(19) United States
(12) Patent Application Publication
(10) Pub. No.: US 2014/0046775 A1
(43) Pub. Date: Feb. 13, 2014

(54) METHOD, SYSTEM AND APPARATUS FOR SYNCHRONIZING RADIO CONTENT AND EXTERNAL CONTENT

(71) Applicant: Joseph HARB, Woodinville, WA (US)

(72) Inventor: Joseph HARB, Woodinville, WA (US)

(21) Appl. No.: 13/853,511

(22) Filed: Mar. 29, 2013

Related U.S. Application Data
(63) Continuation-in-part of application No. 13/544,932, filed on Jul. 9, 2012.
Application No. 13/544,932 is a continuation-in-part of application No. 12/391,221, filed on Feb. 23, 2009, now Pat. No. 8,462,645.
(60) Provisional application No. 61/617,549, filed on Mar. 29, 2012.
(60) Provisional application No. 61/505,515, filed on Jul. 7, 2011.

(51) Int. Cl. G06Q 30/02

(52) U.S. Cl. CPC G06Q 30/0269
USPC 705/14.66

(57) ABSTRACT

Method and device for: receiving station identified content data, receiving a request for synchronized content from a user device, identifying station identified content identifiers in the station identified content data, identifying and retrieving content associated with the identifiers from an external repository, synchronizing retrieved content with station identified content data, and sending synchronized content to the user device.

### RELATED PATENTS

This application claims priority to U.S. Provisional Patent Application No. 61/617,549, filed Mar. 29, 2012, and is a continuation-in-part of U.S. patent application Ser. No. 13/544,932, filed Jul. 9, 2012, which claims priority to U.S. Provisional Patent Application No. 61/505,515, filed Jul. 7, 2011, and is a continuation-in-part of U.S. patent application Ser. No. 12/391,221, filed Feb. 23, 2009, all of which are incorporated herein by reference in their entireties.

### TECHNICAL FIELD

Methods and devices for interactive radio advertising.

### BACKGROUND

Traditional radio lacks a visual/tactile component. As the consuming public increases dependence on immediate access to content, products and services via personal electronic devices such as smart phones, laptops, notepads and etc., it is becoming increasingly difficult for radio stations to engage listeners and to incentivize them to take action based on information that is being broadcast whether the information being broadcast is advertising, polling, and/or other types of programming. Since its inception, the radio has evolved in terms of technology and quality of sound, but not in terms of becoming interactive. Currently, a listener may not interact with broadcast radio on multiple platforms to obtain information, share information, and take other actions in response to items heard on the radio, in a timely and convenient manner. Furthermore, conventional radio advertising is not conveniently available on multiple platforms and formats nor are advertising campaigns conveniently coordinated across multiple platforms and formats.

### BRIEF DESCRIPTION OF THE DRAWINGS

FIG. 1a depicts a system for interactive radio advertising.

FIG. 1b depicts a system for interactive radio advertising.

FIG. 2 depicts an example of an integrated and interactive radio advertising campaign.

FIG. 3 illustrates an example of a user interface comprising an interactive panel.

FIG. 4 is a flow diagram illustrating a method for interactive radio advertising.

FIG. 5 illustrates an example of a user interface comprising an interactive panel

FIG. 6 depicts an interactive radio programming mobile interface for an alert application.

FIG. 7 depicts an example of an interactive radio programming user interface 700 for a backend customer service and upload (BCSU) application.

FIG. 8 depicts an interactive radio programming user interface.

FIG. 9a depicts interactive radio programming interface for coupon distribution.

FIG. 9b depicts a flow diagram related to coupon distribution in an interactive radio programming system.

FIG. 10 depicts an interactive radio programming user interface.

FIG. 11 depicts a Now Playing widget 1100 that may be web based and integrated in the home page of a radio station website hosted by radio station server 102.

FIG. 12 depicts a process for providing interactive radio service.

FIG. 13 depicts an example of a system for synchronizing radio content and external content.

FIG. 14 depicts an example of a system for synchronizing radio content and external content.

FIG. 15 depicts an example of a GUI for a player for a system for synchronizing radio content and external content.

FIG. 16 depicts an example of a display for synchronizing radio content and external content.

FIG. 17 depicts an example of a display for synchronizing radio content and external content.

FIG. 18 depicts an example of a display for synchronizing radio content and external content.

FIG. 19 depicts an example of a process for synchronizing radio content and external content.

FIG. 20 depicts an example of a process for synchronizing radio content and external content.

FIG. 21 depicts an example of a system for synchronizing radio content and external content.

### DESCRIPTION OF EXAMPLE EMBODIMENTS

### Overview

In an example, Interactive Radio Server 104 enables listeners to interact with broadcast radio at multiple levels rendering it a clickable interactive and measurable media enabling sales of advertised consumer goods or services at the click of a button. interactive radio server 104 may be configured to provide one or more of the following: interactive advertising, interactive programming, radio on-demand, interactive music, and/or mobile marketing. interactive radio server 104 may provide an avenue to listeners to connect and engage with radio programming and advertising. For example, listeners may hear an advertisement for a product on the radio, see the brand name and slogan of the product on a car stereo display, see a coupon code number associated with the product on the car stereo display, access a coupon for a discount on the product via a website associated with the radio station, access the website associated with the radio station where a video of the advertisement may be accessed from a station playlist posted on the website or may be streaming in real-time while the advertisement airs and/or may select the advertisement from the radio station playlist to access a coupon or static advertisement (e.g., background skin or panel advertisement). Thus, interactive radio server 104 may coordinate an interactive and multi-platform advertising campaign.

In an example, broadcast radio listeners may react to radio content via rating and voting as well as requesting alerts for specific content. interactive radio server 104 may monitor voting and requests giving broadcasters data to enhance programming to improve advertiser targeting. interactive radio server 104 may monitor linking to advertiser coupons, advertisements, media items in a playlist and/or other content via a radio station website served by interactive radio server 104. interactive radio server 104 may compile statistics based on the monitoring. Radio content and advertising may also be shared through social networks via links to the advertiser coupons and/or other content via a radio station website served by interactive radio server 104 and/or radio station server 102.

In an example, user activity associated with the several different applications described below may be logged. interactive radio server 104 may produce reports associating media items and various recorded user behaviors such as clicking on songs, clicking on advertisements, sms messaging responsive to supplemental data 128 display on user devices. The report may correlate monitored user behavior with respect to time of day, from which communication device was supplemental data 129 or 128 accessed, what songs played before or after, what playlist ordering achieved the best results, and etc.

Several examples of the present application will now be described with reference to the accompanying drawings. Various other examples of the disclosed technology are also possible and practical. This application may be exemplified in many different forms and should not be construed as being limited to the examples set forth herein. The figures listed above illustrate various examples of the application and the operation of such examples. In the figures, the size of the boxes is not intended to represent the size of the various physical components. Only those parts of the various units are shown and described which are necessary to convey an understanding of the examples to those skilled in the art.

Additional aspects and advantages will be apparent from the following detailed description of example embodiments. The illustrated example embodiments and features are offered by way of example and not limitation. Furthermore, the described features, structures, or characteristics may be combined in any suitable manner in one or more example embodiments.

In general, the methodologies of the present disclosed technology may be carried out using one or more digital processors, for example the types of microprocessors that are commonly found in mobile telephones, PC's, servers, laptops, Personal Data Assistants (PDAs) and all manner of desktop or portable electronic appliances.

In the following description, certain specific details of programming, software modules, user selections, network transactions, database queries, database structures, etc., are provided for a thorough understanding of the example embodiments of the disclosed technology. However, those skilled in the art will recognize that the disclosed technology can be practiced without one or more of the specific details, or with other methods, components, materials, etc.

### Example Embodiments

### System

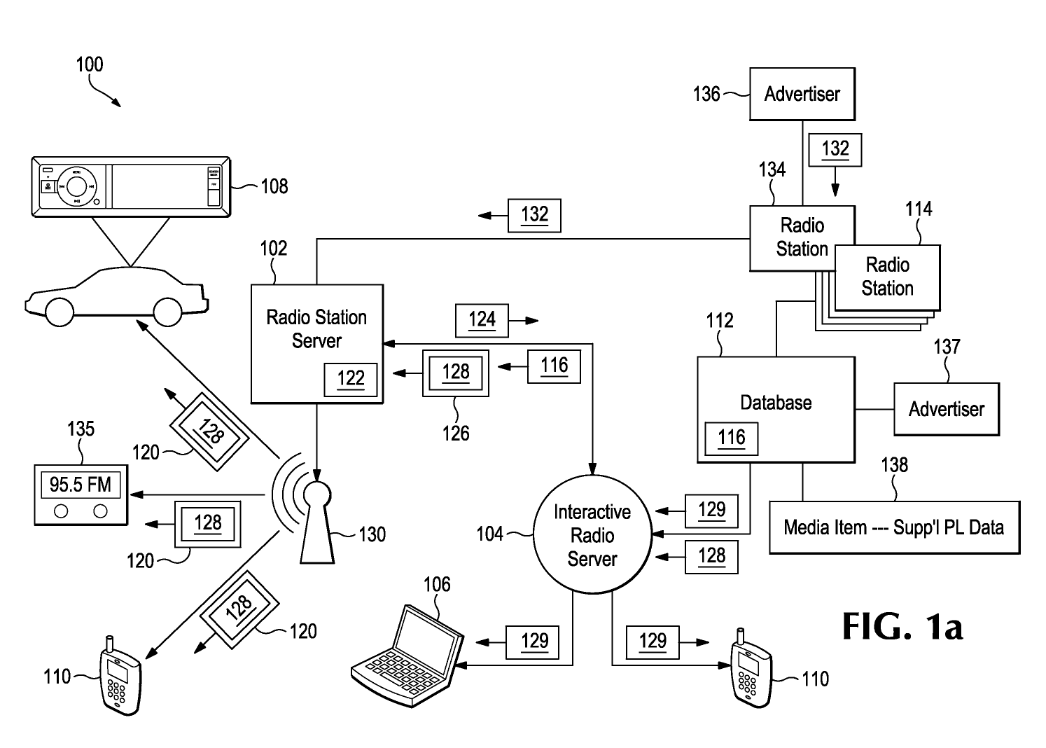

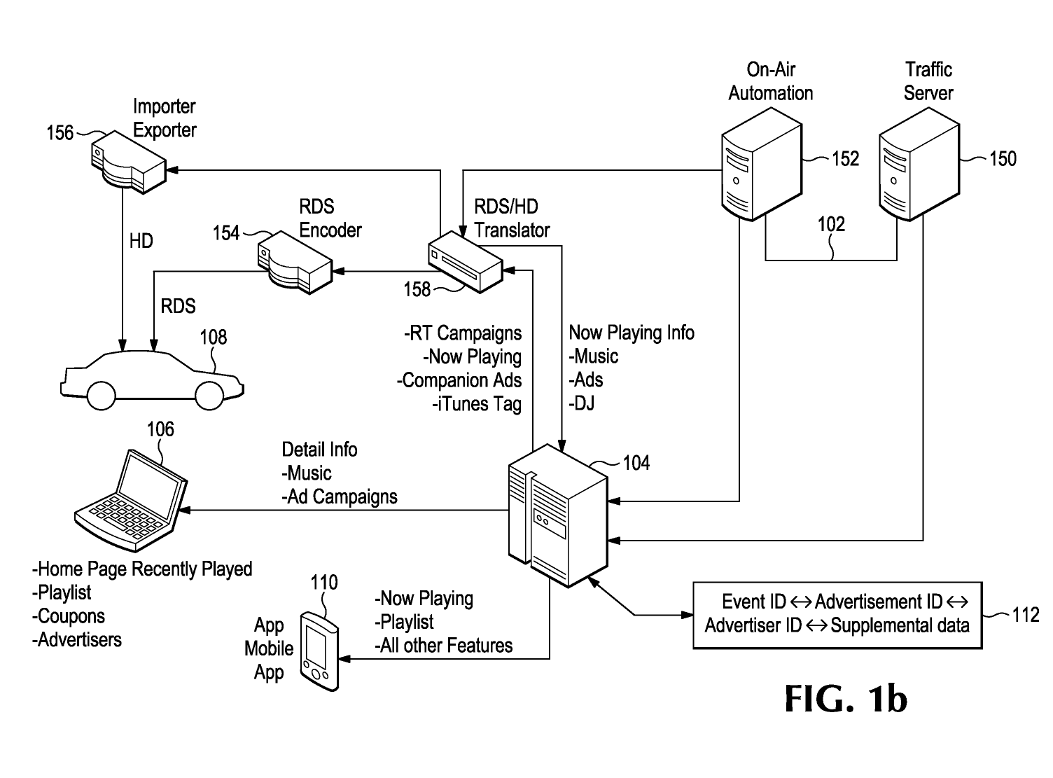

FIG. 1a depicts an example of a system 100 for providing coordinated and interactive radio advertising services to subscriber radio stations and/or advertisers on one or more of a variety of media platforms. In an example, interactive radio server 104 may comprise a service platform and advertising ecosystem to enable radio with on-demand features and interactive capabilities. Radio station 134 may be a subscriber radio station subscribed to interactive radio advertising services provided by interactive radio server 104.

In an example, radio station server 102 may be associated with a radio station 134. Radio station server 102 may identify broadcast programming in real-time in one or more messages 124. Radio station server 102 may send messages 124 to interactive radio station server 102 to identify media items playing in real-time. Interactive radio server 104 may compile a playlist 116 based on messages 124. In another example, radio station server 102 and may send playlist 116 to interactive radio server 104 in advance of broadcasting one or more media items 132.

In one example, each of several media items broadcast by radio station server 102 may each be identified in separate messages 124. The one or more message 124 may comprise an event ID or other data identifying media items 132 as they are broadcast. Media item 132 may comprise entertainment programming, advertising, news, traffic and/or any category of radio programming that may be broadcast.

Playlist 116 may comprise a listing of one or more media items 132 broadcast by the radio station over AM radio, FM radio, RDS, and/or HD Radio. AM radio broadcasting is the process of radio broadcasting using amplitude modulation. FM broadcasting is a broadcasting technology using frequency modulation (FM) to provide high-fidelity sound over broadcast radio. Radio Data System (RDS) is a communications protocol standard for embedding small amounts of digital information (e.g., time, station identification and program information) in conventional FM radio broadcasts. Radio Broadcast Data System (RBDS) is the official name used for the U.S. version of RDS. The two standards are slightly different. HD Radio, (originally “Hybrid Digital Radio”), is the trademark name for iBiquity's in-band on-channel (IBOC) digital radio technology used by AM and FM radio stations to transmit audio and data via a digital signal in conjunction with their analog signals. HD is a digital audio broadcasting method used in the United States. HD Radio allows for an all-digital mode, this system currently is used by some AM and FM radio stations to simulcast both digital and analog audio within the same channel (a hybridized digital-analog signal) as well as to add new FM channels and text information.

In an example, interactive radio server 104 may store playlist 116 in database 112. Playlist 116 data may be stored for any reasonable time period, for example seven days. Playlist 116 may include all or a sub-set of media items 132 broadcast by radio station server 102 during a specified time period. Radio station server 102 may identify which media items 132 are to be identified in playlist 116. For example, some advertisers may not be identified based on an advertising package purchased from radio station 134.

In an example, interactive radio server 104 may store playlist 116 in database 112 and may associate supplemental data 128 and/or supplemental data 129 with corresponding media items identified and/or included in playlist 116. For example, interactive radio server 104 may identify supplemental data 128 and/or supplemental data 129 corresponding to a song identified in playlist 116 and may associate the supplemental data 128 and/or supplemental data 129 with the song in database 112. Database 112 may comprise a single database or a plurality of databases and may be stored in interactive radio server 104 and/or in a different device and claimed subject matter is not limited in this regards.

In an example, the supplemental data 128 may comprise a variety of data types or categories, including: audio data, video data, image data, text data, metadata, song title, lyrics, album, album art, biographical information related to the artist performing the song, advertising data, coupons, coupon code, upcoming local concert dates for the artist, recent news related to the artist and/or a music video related to the song and claimed subject matter is not limited in this regard. In one example, supplemental data 128 may comprise RDS data, RDBS data, and/or HD data. Alternatively, supplemental data 128 may comprise data that is configured to be converted to RDS data, RDBS data, and/or HD data. Supplemental data 129 may comprise: audio data, video data, image data, text data, a song title, lyrics, an album title, album art, metadata, biographical information related to the artist performing the song, advertising data (e.g., image, audio, video, text, etc.), a coupon, coupon code, upcoming local concert dates for the artist, recent news related to the artist and/or a music video and claimed subject matter is not limited in this regard. In one example, supplemental data 129 may comprise data formatted for transmission via the Internet and/or for transmission in a mobile Internet format. Supplemental data 128 and/or 129 may be broadcast via RDS, RBDS and/or HD (in-band on-channel) and/or any of a variety of other broadcasting technologies known to those of skill in the art and claimed subject matter is not limited in this regard.

Interactive radio server 104 may obtain the supplemental data 128 and/or supplemental data 129 from any source, for example, from radio station 134, any of radio stations 114, a third party vendor, any available source via the Internet and/or a database 112.

In an example, one or more media items identified in playlist 116 may be identified with a unique identifier (UID). In another example, interactive radio server 104 may look-up one or more media item UIDs in a table or other data structure based on information in message 124 and/or playlist 116. Playlist 116 may identify one or more media items broadcast over any reasonable time period, such as for example one hour, one day, one week and/or one month.

In an example, radio station server 102 may comprise a station automation system 122 configured to monitor radio station server 102 broadcasting to determine which media item is playing in real-time. Station automation system 122 may send message 124 to interactive radio server 104, identifying the particular media item playing in real-time. In another example, message 124 may identify other real-time broadcast events such as when radio station server 102 is broadcasting DJ chat, a live sporting event, live music, a live interview, a traffic report, a news report, and/or station identification.

In an example, interactive radio server 104 may send supplemental data message 126 to radio station server 102. Supplemental data message 126 may identify and/or comprise supplemental data 128 and/or supplemental data 129 to be broadcast while one or more media items identified in message 124 are being broadcast. Interactive radio server 104 may send supplemental data message 126 to radio station server 102 responsive to receiving message 124 identifying the particular media item playing in real-time. Supplemental data 128 or 129 identified in supplemental data message 126 may be broadcast by radio station server 102 with the particular media item identified in message 124. Supplemental data 128 may be identified in supplemental data message 126 by a UID.

In an example, radio station server 102 may be in communication with transmitter 130. Transmitter 130 may broadcast one or more media items 312 and supplemental data 128 in radio broadcast portion 120. In an example, radio broadcast portion 120 may be transmitted using any of a variety of broadcasting technologies including, for example, AM Radio, FM Radio, RDS, RDBS, and/or HD Radio (in-band on-channel).

In an example, transmitter 130 may send (or transmit) supplemental data 128 in response to receiving supplemental data message 126. Supplemental data 128 and media item 132 may be transmitted together by transmitter 130 to a variety of radio receivers, such as, a radio 135, a car stereo 108 and/or another mobile device such as a radio receiver in a mobile telephone 110.

Substantially simultaneously with broadcasting supplemental data 128, interactive radio server 104 may make accessible the supplemental data 129 for one or more user devices, for example, a laptop computer 106 and/or a mobile telephone 110. Interactive radio server 104 may make accessible the supplemental data 129 responsive to receiving message 124, according to a schedule set-up by a user, and/or responsive to playlist 116. In another example, interactive radio server 104 may store media items 132 including advertising identified on playlist 116 and may playout the one or more media items 132 out of order and/or on-demand responsive to a request from a user device, such as laptop 106 and/or mobile telephone 110. In an example, interactive radio server 104 may transmit the one or more media items 132 identified on playlist 116 via a variety of communication networks, such as; a telecommunication network, the Internet, a private network, or any combination thereof.

In an example, interactive radio server 104 may be coupled to database 112. Database 112 may store data identifying a plurality of subscriber radio stations 114. In an example, subscriber radio stations may access interactive radio services via interactive radio server 104. Radio station 134 may be included in the plurality of subscriber radio stations 114.

In one example, an advertiser 136 may be interested in advertising a product or service on radio utilizing interactive radio advertising. Advertiser 136 may subscribe to radio station 134 advertising services directly. Advertiser 136 may provide or identify media item 132, (such as, a radio advertising media) to radio station 134. Radio advertising media provided to radio station 134 may comprise audio, video, image, and/or text data in a variety of formats configured for display on a radio station website, sending via SMS, as well as for broadcasting over the air in AM, FM, RDS, RDBS and/or HD. Such radio advertising media may be included in playlist 116 and may be broadcast by radio station transmitter 130 according to an agreement between advertiser 136 and radio station 134. An identity of the media item 132 comprising the radio advertising media may be disclosed to interactive radio server 104 in message 124 and may be added to playlist 116 by interactive radio server 104.

As described above, interactive radio server 104 may look-up media item 132 in data structure 138 to determine if there is supplemental data 128 and/or supplemental data 129 associated with media item 132. If there is supplemental data 128 and/or 129 identified in data structure 138, interactive radio server 104 may retrieve the supplemental data 128 and/or supplemental data 129. Interactive radio server 104 may send supplemental data 128 to radio station server 102 to be broadcast (e.g., in RDS, RDBS and/or HD) while the media item 132 is being broadcast. If there is supplemental data 129 identified in data structure 138, interactive radio server 104 may post the supplemental data 129 in the appropriate platform (e.g., on a website associated with radio station 134 and/or sending out alerts, text messages, coupons, and the like).

In another example, advertiser 137 may subscribe to interactive radio advertising services provided by interactive radio server 104 directly. Advertiser 137 may provide or identify media item 132 comprising radio advertising media. Media item 132 may comprise audio, video, image, and/or text data in a variety of formats configured for display on a website associated with radio station 134, communicating via a telecommunications network, sending via short message service (SMS) and/or for broadcasting over the air in AM, FM, RDS, RDBS and/or HD.

In one example, interactive radio server 104 may store media item 132 identifier or the media item itself in data structure 138 and associate supplemental data 128 and/or supplemental data 129 with media item 132. If media item 132 is identified in message 124 and/or playlist 116, interactive radio server 104 may send supplemental data 128 to radio station server 102 to be broadcast while media item 132 is being broadcast over the air by transmitter 130. Interactive radio server 104 may display, link and/or play out media item 132 on a website associated with radio station 134. Interactive radio server 104 may display, link and/or play out supplemental data 129 associated with media item 132 on a website associated with radio station 134. In one example, laptop 106 and/or mobile telephone 110 may access media item 132 and/or supplemental data 129 via interactive radio server 104. Interactive radio server 104 may push media item 132 and/or supplemental data 128 to one or more of radio stations 114. One or more radio stations 114 may broadcast media item 132 and/or supplemental data 128.

In one example, supplemental data 128 may not be associated with media item 132. Advertiser 137 may directly subscribe to interactive radio services provided by interactive radio server 104. Interactive radio server 104 may provide supplemental data 128 to radio station server 102 to broadcast that is not related to the content of a media item currently being broadcast over-the-air. For example, responsive to a request by advertiser 137, interactive radio server 104 may send radio station server 102 supplemental data 128 related to an advertisement for food to be broadcast while a particular song is being broadcast by transmitter 130. When the song is being broadcast by radio station server 102, supplemental data 128 comprising text to display the name of the song and the performer may be displayed on a radio 135 display for a set time period (e.g., 60 seconds) then play a different supplemental data 128 comprising the advertisement for food requested by advertiser 137 may be displayed on a radio 135 display for a set time period (e.g., 30 seconds). The supplemental data 128 may be broadcast by individual radio station 134, or pushed by interactive radio server 104 to one or more of radio stations 114.

In an example, the timing may be coordinated by station automation system 122. However, radio station advertiser 136 or advertisers 137 may log into interactive radio server 104 and access special software (coined “Advertiser Experience”) to schedule supplemental data 128 and/or media item 132 to be broadcast and/or displayed at certain times of day. For example, if advertiser 136 or 137 selects advertising for a Burger Joint, advertiser 136 or 137 may schedule supplemental data 128 text and/or graphics to be broadcast, for example “Get an Egg Sandwich” displaying a picture of a breakfast sandwich between 6 am and 12 pm, then switch to a “Get a Big Burger and a Salad” later in the day and display a graphic showing the burger and salad. Advertiser 136 and/or 137 may select different messages at different times and days of the week or in conjunction with other media items being broadcast by radio 134.

FIG. 1b is a block diagram illustrating a system for providing coordinated and interactive radio advertising services to one or more subscriber radio stations and/or advertisers on one or more of a variety of media platforms.

In an example, a radio station server 102 may comprise two servers, an automation system server 152 and a traffic system server 150. Automation system server 152 may send information to interactive radio server 104 about what is currently being broadcast by the radio station. The current broadcast information may be communicated in message 124 (see FIG. 1). Message 124 may comprise various data types, for example, identification numbers to identify artists and song titles, generic information about an advertisement, identify a DJ talking, and/or identify other programming. In an example, each time a broadcasting event occurs (e.g., playing a song, advertisement and/or when a DJ talks), a new “EVENT” is generated by the automation system server 152. Details regarding the EVENT may be sent in message 124 (e.g., artist and title for a song, generic name for an advertisement etc.) to interactive radio server 104. Each event may be associated with an event ID in interactive radio server 104.

In an example, traffic system server 150 may control trafficking (i.e., timing, scheduling, editing, ordering and/or billing) of advertisements for radio station 134. Radio sales personnel may enter sales orders in the traffic system server 150 and may include information such as the advertiser name (e.g., McDonald's®) the advertisement title, billing details, and/or the approximate times they wish for the advertisement to play. As happens, sales personnel may schedule an advertisement to play at 12:10 pm EST, but in fact the advertisement will probably play at 12:20 pm EST. Each advertisement may be associated with an advertisement ID. The advertisement ID may be the same ID used by the automation system server 152 as the event ID which may be a unique identifier. The unique identifier (event ID) may change on a daily basis.

In an example, sales personnel may enter the information in the traffic system server 150 and request an air time. A program director may review the advertisements for the day and may change the schedule to optimize programming. For example, ads may be scheduled to play certain advertisements after particular songs or other advertisements, or also to avoid playing two competitor's advertisements in consecutive order and/or for additional reasons. When the programming list is refined, it may be transmitted to an automation technician who may schedule the advertisements to play as per the program director instructions. The advertisements may be entered in a database associated with automation system server 152. A different description of the advertisement may be entered into the automation system server 152.

In an example, interactive radio server 104 may receive trafficking data from traffic server 150 comprising a daily listing of advertisers and advertisements to be played for the day, the listing may include advertisement IDs and/or advertiser IDs and/or timing information. In another example, the trafficking data may be a bare listing of advertisement and advertiser IDs with no timing information. interactive radio server 104 may store the trafficking data in database 112 (see FIG. 1a). As advertisements are broadcast by radio station server 102, interactive radio server 104 may receive automation data from automation system server 152, for example in message 124. interactive radio server 104 may compare the trafficking data to the automation data as it comes in real time. An advertisement ID may be the same ID used by the automation system server 152 as the event ID. Thus, based on an advertisement ID received in the trafficking data, interactive radio server 104 may associate an advertisement playing over the air identified with a particular event ID with the advertiser identified in the trafficking data. interactive radio server may access database 112 where an advertiser may be associated with supplemental data 128 (FIG. 1a) that is configured or may be configured to be played and/or displayed in a variety of formats including, for example, RDS, HD, RDBS, SMS, and/or data and graphic formats for display on an Internet website or mobile device. In an example, supplemental data 128 to be transmitted to a car stereo may be formatted to RDS and/or HD by RDS/HD translator 158 and RDS encoder 154 or importer/exporter 156.

In an example, interactive radio server 104 may permit users to create items, containing supplemental data 128 or 129 to be displayed on a radio's assets (e.g., car stereo, Internet website, and mobile website). An item created by the user may be associated to an advertiser identified in the trafficking data. Therefore when an advertisement plays over the air, interactive radio server 104 may receive an event ID that can be associated to the advertiser as described above and the interactive radio server 104 may look up in database 112 what supplemental data 128 needs to be displayed on the car stereo, on the Internet and/or on the mobile platform and may send the supplemental data 128 to the pertinent outlet (e.g., laptop 106, mobile phone 110 and/or radio station server 102 (for RDS/HD)). Supplemental data 128 may be time/day/date/station specific. For example when a McDonald's® advertisement plays in the morning, and Egg McMuffin may be displayed, changing it at noon to a Big Mac.

Radio station server may transmit for display the name of the advertiser may not necessarily be the name identified by the automation system server 152 along with a supplemental data 128 such as a call to action or a coupon combining the audio with the visual increasing advertising branding and efficiency. Users may access additional information about the supplemental data 128 displayed by sending a text message to an identified number in the call to action including keywords associated with the supplemental data 128. When users interact they receive additional details on their cell phone including mobile coupons.

Radio station server 102 may send specialized messages to used devices corresponding to the supplemental data 128 to display specialized messages when the DJ is talking and/or when music or other programming is playing.

Messages may be sponsored by advertisers (e.g., “Geico® Save 50% today”) and may be filtered many different ways:

a. Date
b. Day of the week
c. Time specific (multiple times a day)
d. Duration
e. Day part

HD radio messages may also display the advertiser's logo when the advertisement airs or when the sponsorship is displayed. During radio programming such as when music is playing advertising messages may alternate with programming information (e.g. music title/artist name).

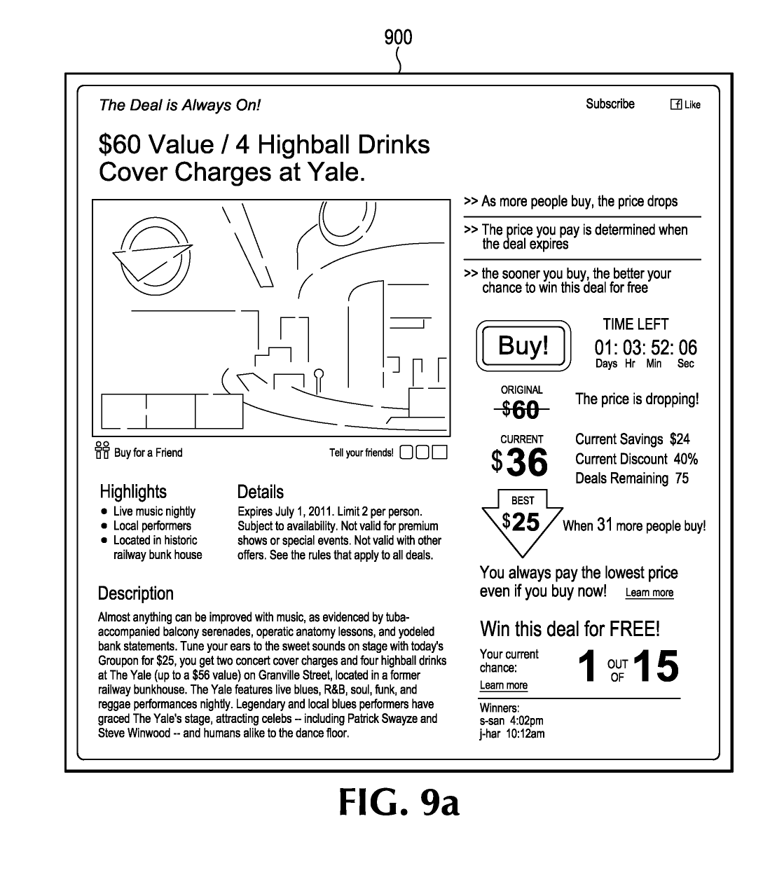

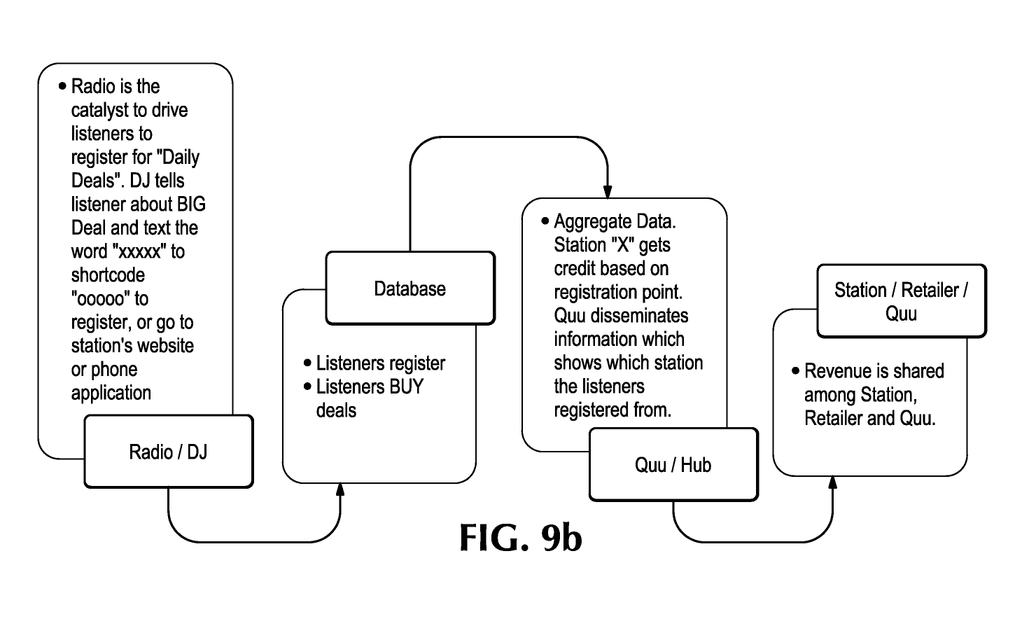

In an example, a media item 132 may be associated with a coupon, either in a daily deal format or in a standalone coupon format that may be accessible in a variety of forms, for example: in bar code form, in an email, over the internet, in a code provided in a text message, in a link to a printable copy of the coupon, in a mobile application and/or directly within the radio station website. Coupons may be offered in a separate website 900 (see FIG. 9a) or integrated in Interactive Panel 300. Mobile users may register and receive daily deals using the station coupons mobile app. User may also, register and receive daily deals via text messaging. In an example, radio DJs may promote the daily deals and drive users to register using any of the three methods above (see FIG. 9b).

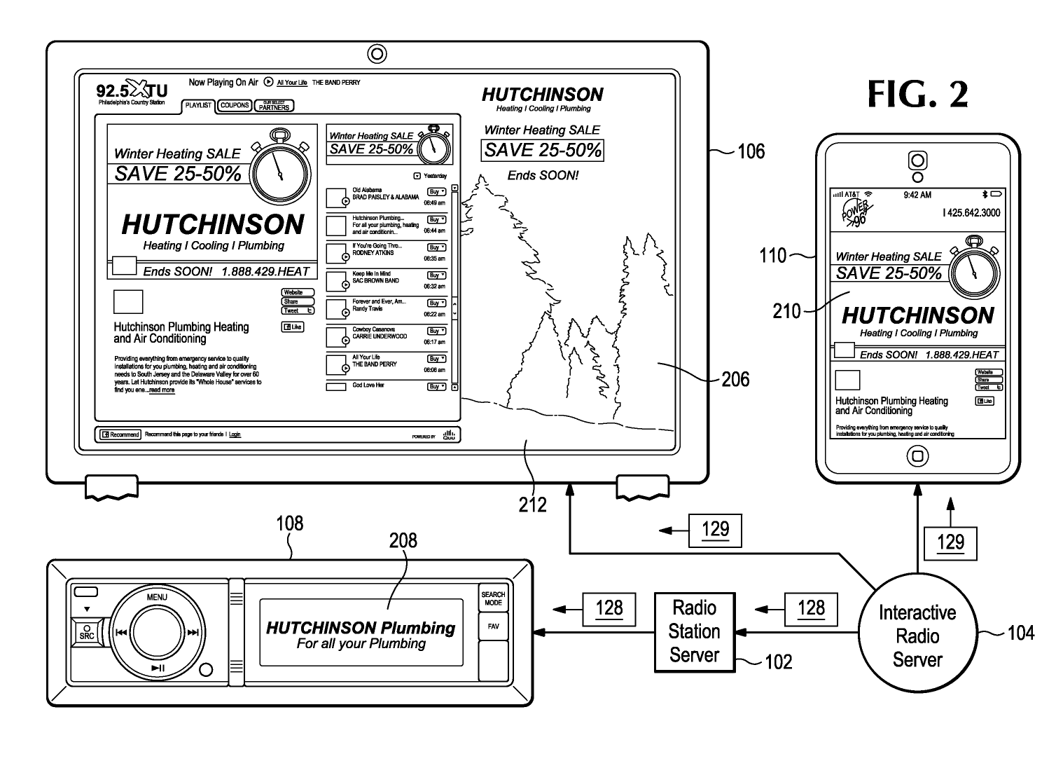

FIG. 2 depicts an example of an integrated and interactive radio advertising campaign coordinated by interactive radio server 104 for Hutchinson Plumbing. Display screens for each of mobile telephone 110, laptop 106 and car stereo 108 are shown displaying advertising for Hutchinson Plumbing. Display of such advertising may be coordinated by interactive radio server 104 and may be shown at substantially the same time of day, responsive to receiving messages 124 and/or in association with a playlist 116. Timing for transmission of supplemental data 128 may be associated with receipt of message 124. In an example, interactive radio server 104 may also associate display of advertising data related to Hutchinson Plumbing in a website associated the radio station 134 with broadcasting of an audio advertisement by radio station server 102.

In an example, Hutchinson Plumbing may be an advertiser 137 and/or advertiser 136 as described with respect to FIG. 1. Display screen 208 on car stereo 108 may display supplemental data 128 comprising text data for advertising “Hutchinson Plumbing” including the slogan, “For all Your Plumbing” via RDS, RDBS and/or HD data. The text data may be displayed while radio station server 102 is broadcasting an audio advertisement for Hutchinson Plumbing. The supplemental data 128 may be communicated to radio station server 102 from interactive radio server 104 and may identify an association with the Hutchinson audio advertisement (a media items 132) identified as currently being broadcast in message 124. Radio station server 102 may broadcast media item 132 and supplemental data 128 together.

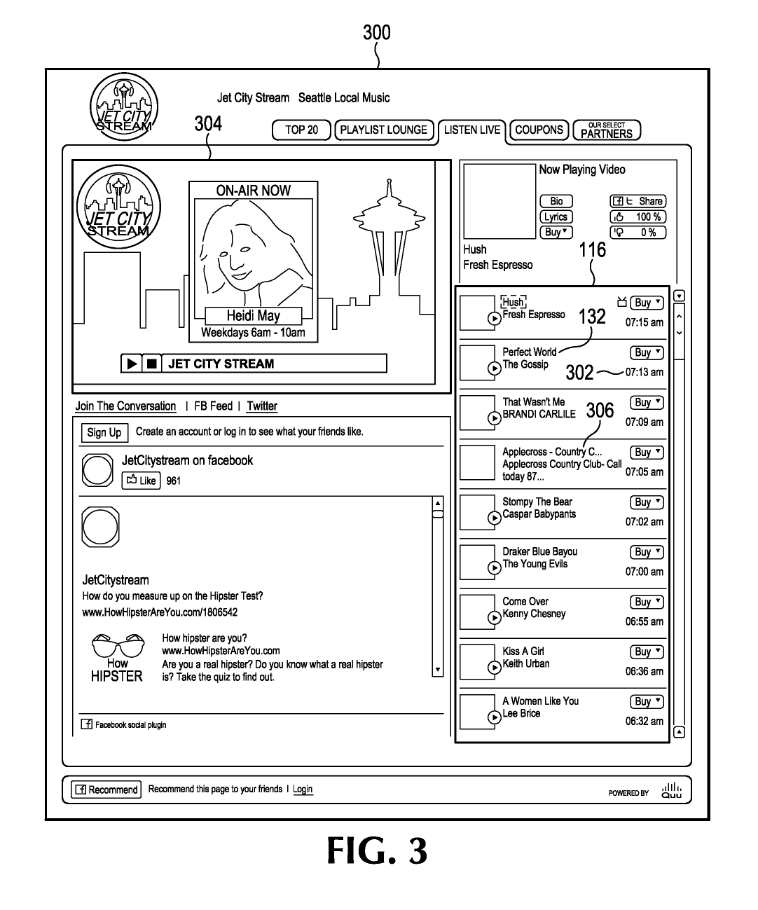

In an example, laptop 106 may access interactive radio server 104 to display website 212. Website 212 may be associated with radio station 134 and may be configured to display a variety of media items related to radio station 134 broadcast activities. For example, website 212 may display a playlist and advertising. Website 212 may display supplemental data 129 comprising one or more advertisements for Hutchinson Plumbing when radio station server 102 is broadcasting supplemental data 128. Website 212 may comprise Interactive Playlist Panel 300 discussed in great detail with respect to FIG. 3. Display screen 210 on mobile telephone 110 displays a user interface for mobile Internet comprising supplemental data 129 as well.

### Mobile Device Tagging

In an example, a user may tag radio advertisements using SMS text messaging. In an example, when a user hears an advertisement the user may send a text message to a radio station using a specific keyword to receive information back in a text message. The information may include a link to a webpage generated automatically based on the selection and may be hosted by interactive radio server 104. The webpage may be specific to the advertisement containing the interactive information and/or a mobile coupon.

### Email Marketing

In an example, a user may access email marketing features including an easy and powerful interface allowing radio stations to create and distribute marketing material to user databases via interactive radio server 104.

### Ad Play Validation

In an example, an advertiser may login to interactive radio server 104 to check advertisement playtimes on select stations giving them a third party validation to the true times their advertisements aired. This information may be compiled based on playlist 116. This feature addresses a major issue in radio where the scheduled advertisements provided to advertisers and the real time the advertisements aired are not the same. Currently advertisers subscribe with providers such as Media Guide to provide them with this data.

### Third Party Applications

Interactive radio server 104 may communicate advertising data with third party applications or phone applications or SMS providers so that radio stations using those applications may take full advantage of coupons capabilities without changing their providers.

### Interactive Playlist Panel (IPP)

FIG. 3 illustrates an example of a user interface comprising an interactive panel 300. Interactive panel 300 displays playlist 116. Playlist 116 may be compiled by interactive radio server 104 based on one or more messages 124 identifying media item 132 as it is being broadcast by transmitter 130 substantially in real-time. Playlist 116 may include a listing of radio station 134 programming including advertising, music, DJ talk, interviews and/or other programming for any reasonable period of time, for example, seven days. interactive radio server 104 may display a version of playlist 116 in interactive panel 300. Playlist 116 as displayed in panel 300 may be configured to include at least one of the following: media item 132 identifier (e.g., a name of song, an advertiser name, a name of on-air personality corresponding to programming included in playlist 116, or combinations thereof), a time stamp 302 indicating when media item 132 was broadcast by radio station 134, a link 304 to a video that may be embedded and associated with media item 132 and a trigger to change a background skin. Such a trigger 306 may be associated with a link to access a particular media item.

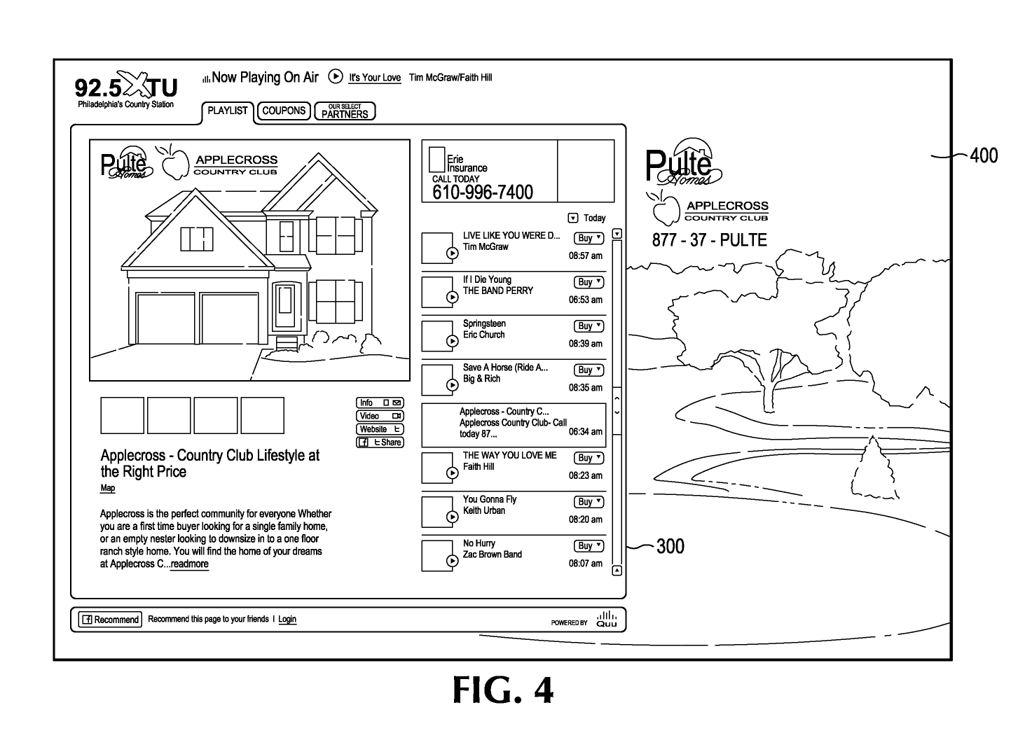

In an example, panel 300 may be associated with a website provided by interactive radio server 104 and may be a central portal for one or more other websites integrated by interactive radio server 104 in panel 300. Panel 300 may be invoked from within a separate website hosted by radio station server 102 (or another server associated with radio station 134). In one example, a panel 300 website may be accessed through a Now Playing widget on a different website. Panel 300 may also include the following: detailed information on music, detailed information on advertisements, links: to coupons, featured products, events, daily deals, Watch Radio On-Demand, and/or search capability for music and advertisements. In an example, an advertiser may sponsor the playlist 116 and/or background skin 400 (see FIG. 4).

When users click (select with a mouse) on a song they may be direct to another website to purchase the identified media item 132, download a ringtone associated with the media item 132, view artist biographical information and lyrics, add media item 132 to a preference list, and/or set mobile alerts when the media item 132 plays the radio or when an associated artist plays on the radio, or combinations thereof.

When users click on a media item 132 that is an advertisement they may request more information from the advertiser by filling a request form, listen to the audio from an associated Radio advertisement or infomercial, watch a video related to the media item 132 (e.g., television advertisement or infomercial), download mobile or printable coupons, receive daily deals, read the detailed description, link to the advertiser coupons website and map, and/or share information about the advertisement through a social network, or any combination thereof.

### Pop-Ups

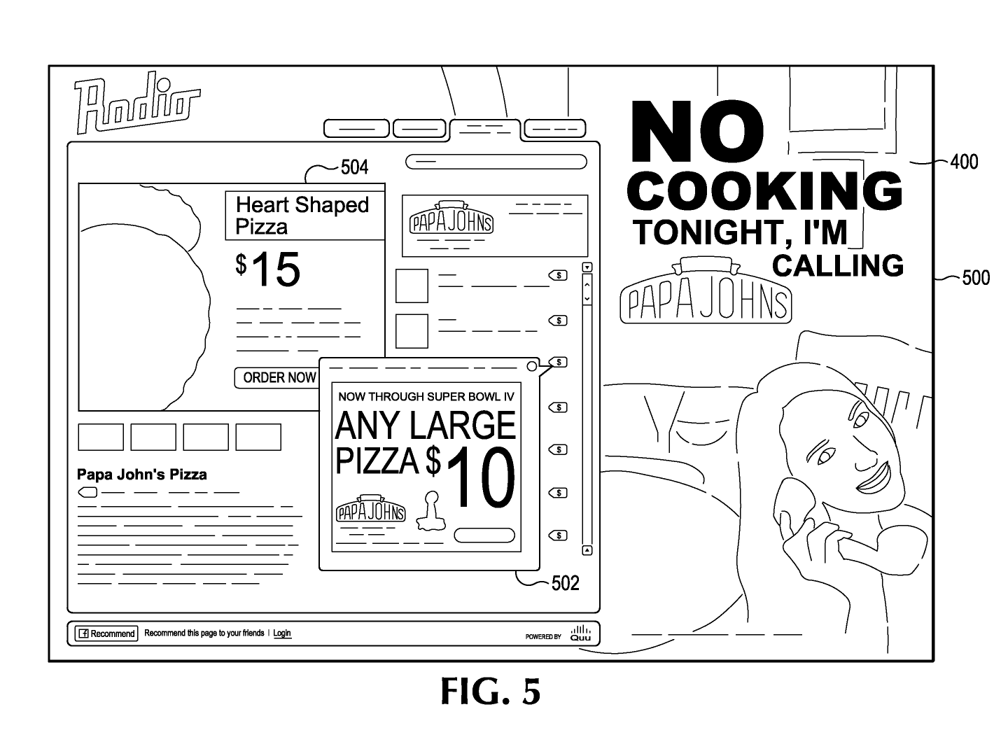

FIG. 5 illustrates an example of a user interface comprising an interactive panel 500. From the display of playlist 116 in interactive panel 500, a pop-up window 502 may be activated when a user selects a corresponding media item 132 in playlist 116. Selecting the media item may activate interactive radio server 104 to change a background skin and/or to embed a coupon 504 in interactive panel 500 associated with the media item 132.

### Alerts

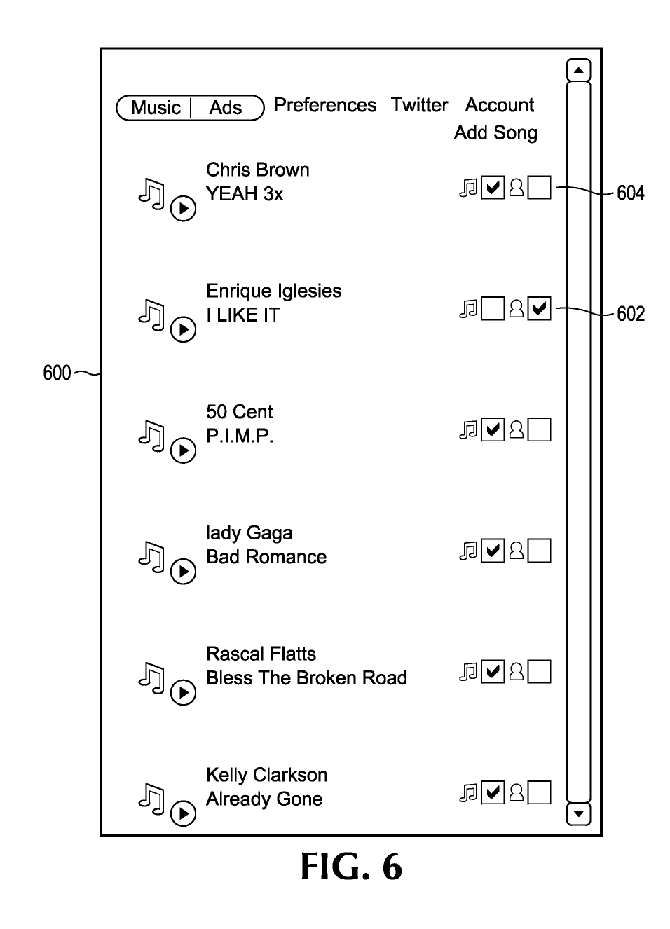

FIG. 6 depicts an interactive radio programming mobile interface 600 for an alert application that may run on interactive radio server 104 or any other appropriate device. A user may access the application via a variety of devices including: a mobile device such as a cell phone, a computer, a laptop, and/or a notepad. The alert application may be used to create mobile alerts to notify a user that a selected media item 132 in playing on the radio. Alerts may be sent to the user device based on message 124. Alerts may be created in from the radio station website hosted by radio station server 102 and/or users may register via an interactive radio server 104 hosted website. To register a user merely identifies a media item of interest and a device to which an alert is to be sent. The alert application may search for the identified media and send an alert to an identified device. Alerts may be based on an associated radio station 134 playlist 116. Users may indicate whether the alert should be based on a particular media item 602 or an artist 604 who may be associated with several media items in a playlist. In an example, their cell phones using text messaging listeners may register and search for music directly from their phones. From their cell phones accessing interactive radio server 104 or radio station server 102 listeners may create alerts using the alert application and receive alerts either via the application via the Internet, mobile Internet or a text message. A listener may set their preferences to how often to receive alerts as well as turn off the alerts during the night.

### Mobile Device Tagging

Listeners may tag music or advertisements using simple text messaging. When a user hears an advertisement he/she may simply text a station keyword to a phone number identified in the broadcast. In response, listeners may receive a text message containing the more information about products, services, name of the song and/or the artist.

### Business Interface

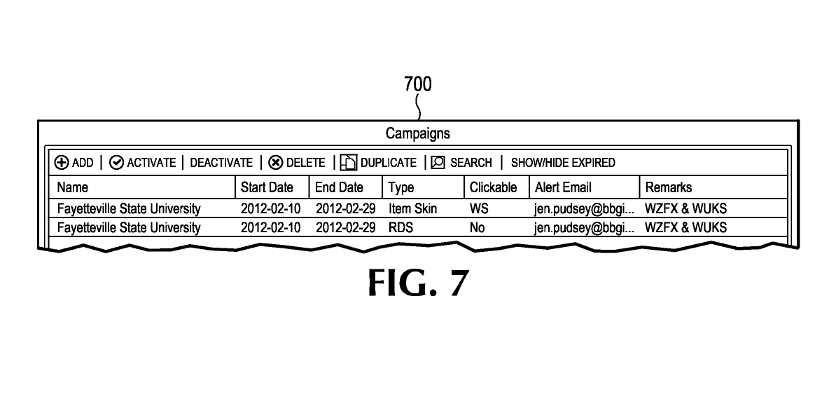

FIG. 7 depicts an example of an interactive radio programming user interface 700 for a backend customer service and upload (BCSU) application that may run on interactive radio server 104 or any other appropriate device. The BCSU application may facilitate communication between interactive radio server 104 and an advertiser 136 or 137 and/or a radio station 132. The BCSU application may be web based and designed for radio advertising sales departments. The BCSU application may allow radio station or advertising personnel to upload media rich information such as pictures video description etc. and attach the uploaded media to an advertisement identified in the playlist 116. In an example, a user may request that the advertisement be made interactive by selecting one or more campaign types, including, for example: on-air, online, background skin, supplemental data RBDS, supplemental data RDS, supplemental data HD, SMSI mobile coupon, and/or print coupon, any combinations thereof. Campaign types may include other categories and claimed subject matter is not limited in this regard.

### Interactive Programming

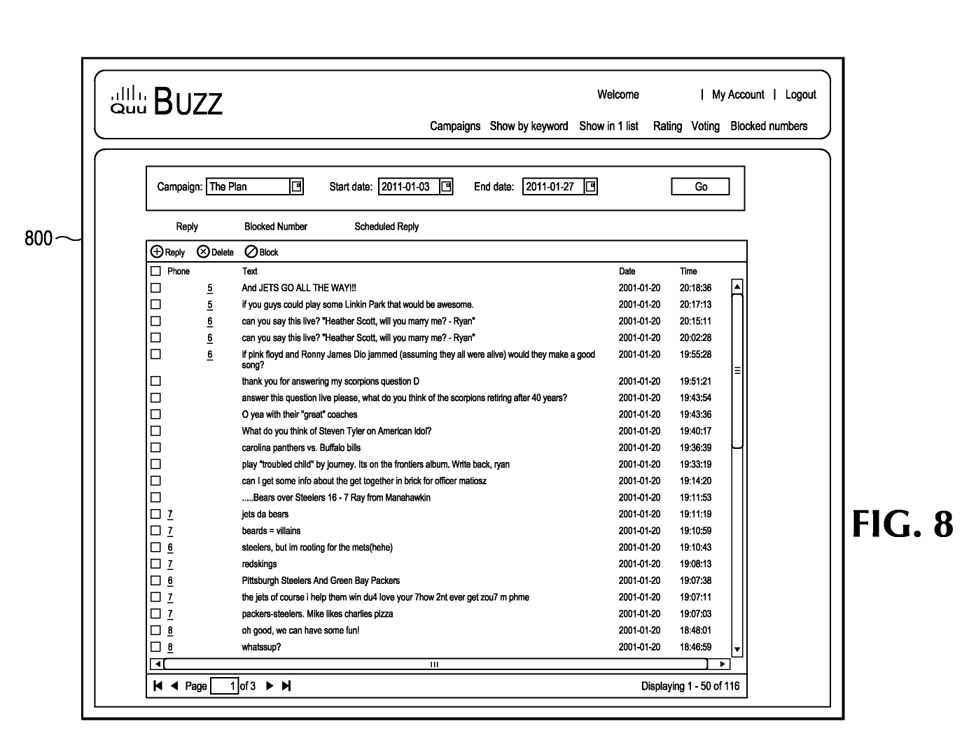

FIG. 8 depicts an interactive radio programming user interface 800 for an interactive radio programming (interactive radioP) application that may run on interactive radio server 104 or any other appropriate device. The interactive radioP application may facilitate communication between users and radio station personnel such as Disc Jockeys (DJs), on-air talent and/or with each other. Users may send a response to votes solicited by radio station DJ during programming. Users may also opt-in via the radio station website to receive updates on different subjects such as emergencies or news. A DJ may control interaction from a single control panel and may respond to one or more users at the same time. The interaction may take place through multiple outlets.

In an example, short message system (SMS) users may send text messages to correspond with the DJ and may receive replies from the DJ through the user interface 800. Users may also receive text message alerts or reminders on subjects or shows they are interested in via other user devices such as laptop 106 and/or mobile phone 110.

In an example, through an interactive panel chat room users may interact with the DJ as well as each other. The DJ may receive the comments in the same panel where he/she views the sms messages combining online and offline users. Messages, comments, votes and/or other interactions with users may be displayed in user interface 800.

In another example, a user may send a text message to a radio station telephone to request the name of a song, to get alerts when their favorite music is playing, send comments to the station, vote and/or rate and receive updates on subjects of interest or mobile coupons. The radio station may respond with requested information as well as supplemental data 128 including coupons or other advertising vehicles.

### Daily Deals and Coupons

In an example, coupons associated with media items 132 may be available via a website hosted by radio station server 102 or via Interactive Panel 300. In an embodiment, users may register and receive daily deals via a radio station website or via interactive panel 300. In another example, coupons may be available from a separate daily deal website 900 as shown in FIG. 9a.

In another example, consumers may register and receive daily deals via text messaging. For example, radio DJs may promote the daily deals and drive listeners to register using any of the methods discussed above. Hence coupons engage listeners increase station website traffic and boost revenue (see FIG. 9b).

### WatchRadio On-Demand (WROD)

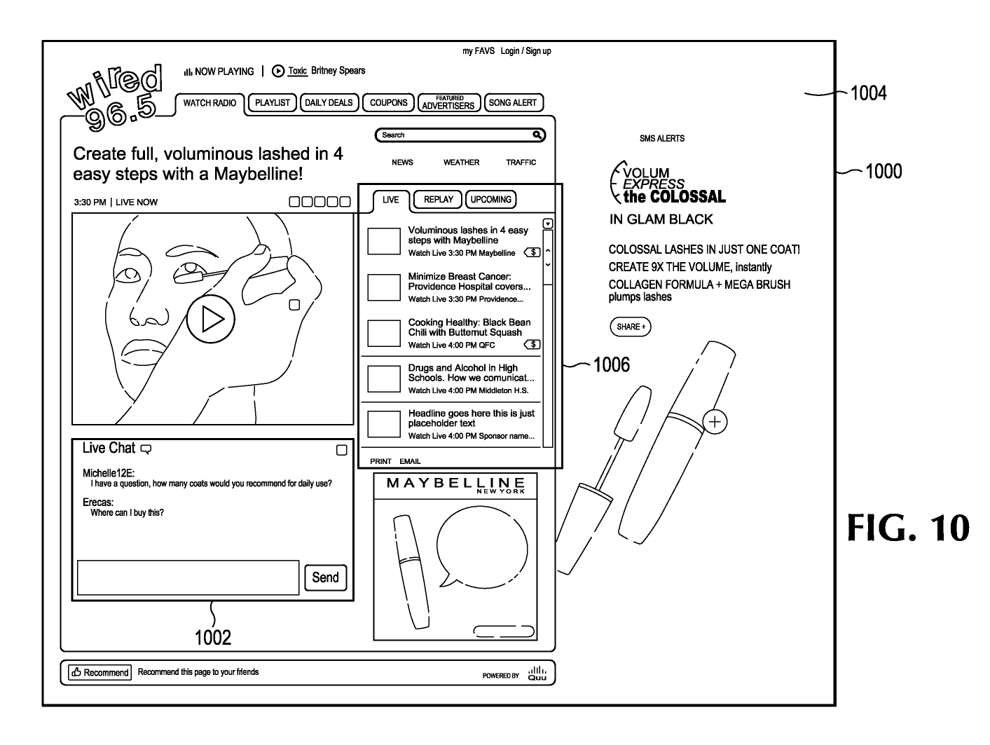

FIG. 10 depicts a user interface 1000 for an application to facilitate video display during a corresponding radio broadcast (coined WatchRadio On-Demand). The video display application may be accessed by a user via interactive radio server 104 or another appropriate device. WROD displays a live or prerecorded stream of video content that may be streamed to a radio station website by interactive radio server 104 (or another device) while a radio broadcast associated with the streaming video content is being broadcast by radio station server 102. In an example, a user may chat with a presenter featured in the streaming video while the programming is being performed and broadcast live. Similarly, a user may chat with other users during the live broadcast. Live chat may be displayed in panel 1002. A background skin 1004 may be configured to advertise a product featured in the video.

In another example, user interface 1000 provide a link or an panel featuring a coupon for the product featured in the streaming video or may offer a different unrelated product. The type of videos available may be catered to the station demographic audience. In an example, radio station server 102 may broadcast live video from within the radio station 134 studio letting listeners watch the DJ and chat with him/her as well as amongst each other. When a radio advertisement plays the video of the advertisement if available and may automatically start playing. Videos may be archived and made available via user interface 1000, for example, in panel 1006. The product offers many features such as but not limited to: preshow video, advertising, pay-per-view, user registration, consumer feedback and etc. In an example, video may be provided by a third party vendor and presented in an iframe within a website associated with radio station 134 and may be server by interactive radio server 104.

### Mobile Marketing

interactive radio server 104 may coordinate a mobile marketing campaign making detailed information about a traditional advertisement (e.g., radio, TV, billboard etc.) available to consumers via a texting campaign. In an example, a keyword consumers may text to request more information may be associated with media items 132, supplemental data 128 and/or supplemental data 129. When consumers send the keyword in a text message to the identified number, the interactive content is sent to their cell phones along with coupons when available.

### Now Playing (NP)

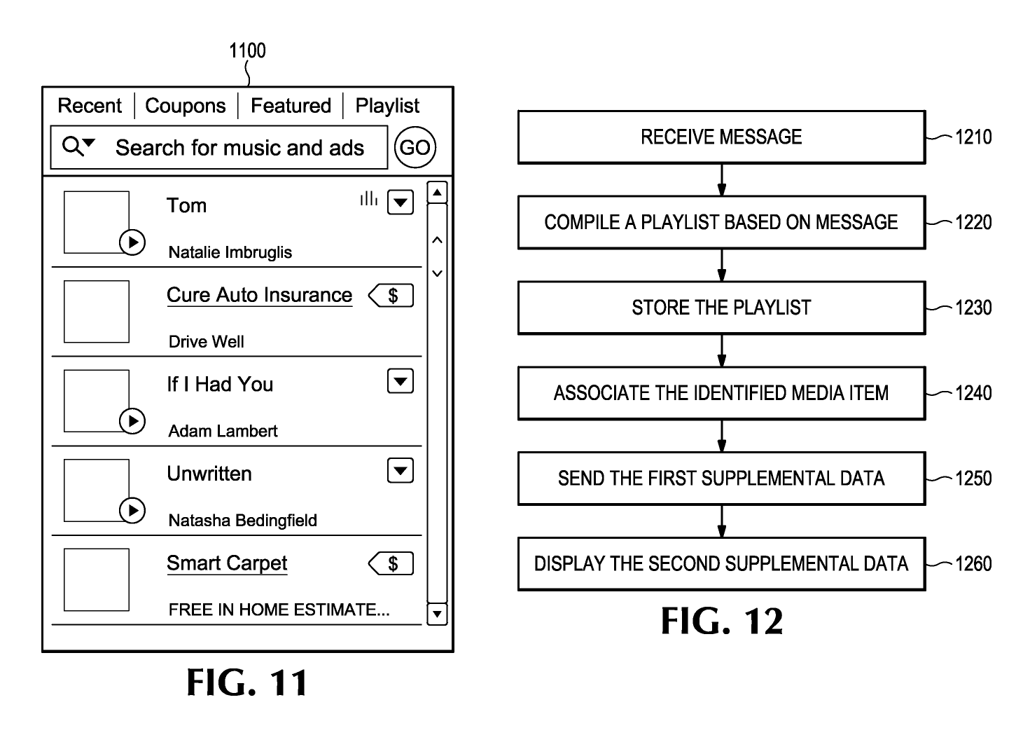

FIG. 11 depicts a Now Playing widget 1100 that may be web based and integrated in the home page of a radio station website hosted by radio station server 102. The features of the NP include:

a. It features the most recent songs and advertisements played on the air. Both are clickable. One or both may be based on playlist 116 received from interactive radio server 104.
b. Quick links to coupons and featured products or events.
c. Quick Search for advertisements and music.
d. The widget may be sponsored by one or more advertisers.
e. Appearance and size are configurable to match radio branding.

In an example, a user may access Interactive Panel 300 from the radio station website. In one example, Interactive Panel 300 may be accessed when a user selects a feature of the Now Playing widget.

In an example, a user may insert advertising in the Now Playing widget in four different ways:

a. In the playlist in between songs both in NP and QIP.
b. As a background skin in the QIP.
c. As a large advertisement in the QIP prior to displaying any song details when the user opens the page.

When a user clicks on a song or an advertisement it opens an Interactive Panel 300 which displays the details pertaining to the song or advertisement they clicked on. Listeners may purchase songs from iTunes® or Amazon® to download the ringtone examine the lyrics and artist bio or add the song to their favorites list or alerts (described above).

If users share the song or the advertisement through Facebook®, Twitter® and other social networks, the shared link may open the Interactive Panel 300 of the originating radio station. Hence the station benefits in increased website traffic.

FIG. 12 depicts a process 1200 for providing interactive radio service. In operation 1210 an interactive radio server receives a message identifying a media item comprising a song or an advertisement, or a combination thereof. In operation 1220, the interactive radio server compiles a playlist based on the message, wherein the playlist identifies a plurality of media items comprising at least one advertisement and at least one song. In operation 1230, the interactive radio server stores the playlist in a database. In operation 1240, the interactive radio server associates the identified media item with a first supplemental data and a second supplemental data. In operation 1250, the interactive radio server sends the first supplemental data to a radio station server to be broadcast substantially simultaneously with the associated media item. In operation 1260, the interactive radio server displays the second supplemental data on a website, wherein the website is configured to be accessed by a computer and a mobile device.

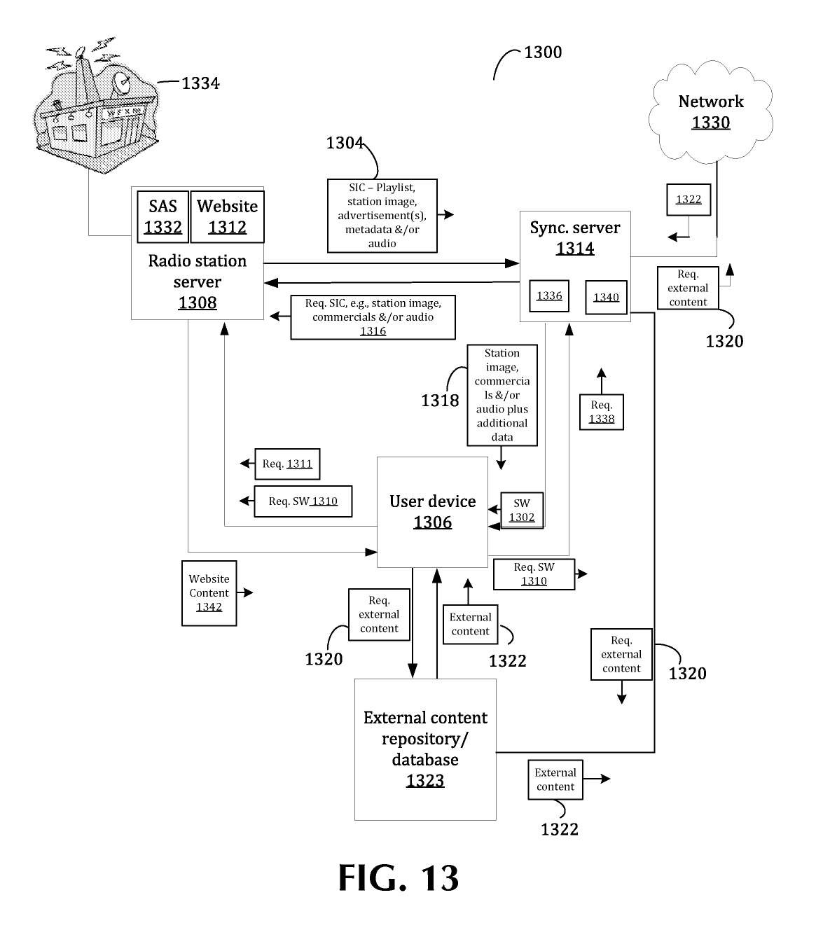

FIG. 13 depicts an example of a system 1300 for external content integration, synchronization and cross-platform advertising synchronization in third-party devices. In an example, radio station 1334 may generate content which may be identified in station identified content (SIC) 1304 generated by Station Automation System (SAS) 1332 and may include any radio station intellectual property such as: a playlist of songs and/or other radio station content, commercials, station imaging and/or any media content provided by the radio station via any transmission method. In an example, system 1300 may present SIC 1304 in a format synchronized to the actual over-the-air broadcast of a radio station—virtually in ‘real-time’ or in random order.

In an embodiment, a user device 1306 may access station identified content and/or synchronization content 1318. In another embodiment, application software 1302 sent from synchronization server 1314 may enable user device 1306 to access music station identified content (SIC) 1304 and/or synchronized content 1318. In an example, user device 1306 may comprise a computer, a tablet, a billboard, electronic sign, in-car radio equipped with RDS or HD, a mobile telecommunication device and/or the like.

In an example, when a user accesses radio station website 1312 from radio station server 1308, synchronization server 1314 may be accessed and may provide a video presentation experience like that of a television or cable TV channel, effectively presenting a radio station as a video channel via player 1340. In an embodiment, player 1340 may provide user device 1306 with synchronized content via synchronization server 1314.

In an embodiment, user device 1306 may send a request 1310 for synchronization application software 1302 to synchronization server 1314. Server 1314 may send application software 1302 to user device 1306 for downloading to user device 1306.

In an alternative embodiment the software 1302 may be sent to user device 1306 by radio station server 1308.

In an embodiment, upon accessing radio station website 1312, user device 1306 may send a request 1338 for SIC 1304 and/or synchronized content 1318 to synchronization server 1314. In one example, request 1338 may be sent by user device 1306 responsive to downloading application software 1302. A request 1338 for SIC 1304 and/or synchronized content 1318 may comprise a request to access any synchronized content including any of: radio station content such as a playlist, images, live stream, audio, external content associated with SIC and the like. In response to request 1308, synchronization server 1314 may send a request 1316 for SIC 1304 to radio station server 1308. In response, radio station server 1308 may send SIC 1304 to synchronization server 1314. In an example, synchronization server 1314 may then forward synchronized content 1318 including requested SIC content 1304 along with synchronized external content 1322 to user device 1306. The external content 1322 included in synchronized content 1318 may comprise ay additional data that is associated with the SIC 1304 such as: artist biography, lyrics, the Uniform Resource Locator (URL) for a matching video publicly available by a service provider such as YouTube or VEVO, advertising, public service announcements, merchant data, social media links and/or the like.

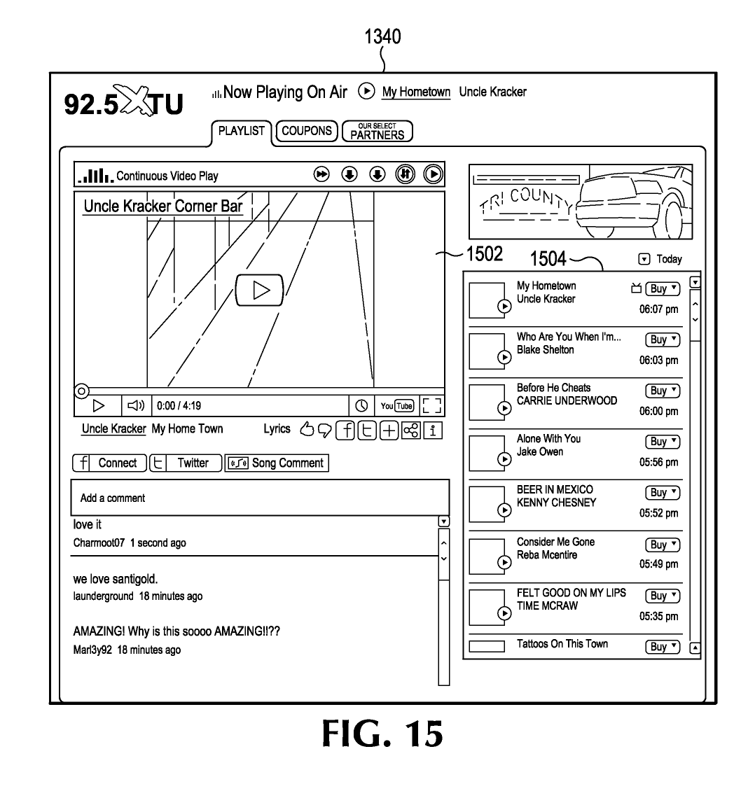

In an example, user device 1306 upon accessing or receiving synchronization content from synchronization server 1314 may receive a link to access additional data such as a video from an external content repository 1323 to play within frame of player 1340 (see FIG. 15 element 1502). In another embodiment, application software 1302 may automatically send a request 1320 for external content 1322 associated with the available video URL received in synchronized content 1318 directly from user device 1306 to an external content repository/database 1324. Responsive to the request 1320, external content repository/database 1324 may send external content 1322 to user device 1306. User device 1306, responsive to application software 1302 instructions may embed external content 1322 such as an associated video within player 1340 and/or website content 1342.

In one embodiment, synchronization server 1314, may be separate from the station server 1308 and may generate synchronized content 1318 by mixing one or more of the following: radio station intellectual property, video, audio, publicly available video on the Internet 1330 (or other network), station imaging (e.g., logos, or pictures of DJs of the radio station), or internal videos, etc. and/or video and/or audio commercials available on the synchronization server 1314 between music videos available from a variety of sources. The radio station server 1308 may comprise a station automation system (SAS) 1332. SAS 1332 may generate and send metadata identifying radio station content such as what songs are playing, artist/title, advertisements, disc jockey talking, and the like with SIC content 1304 to synchronization server 1314. The metadata may identify an order that SIC content 1304 is transmitted from radio station 1334 (e.g., when ads/interviews/songs are playing or the DJ is talking). Music metadata may be assembled using one or more content databases available via Internet 1330 such as YouTube for videos, Lyricfind for lyrics, and/or the like. Advertisement information may be stored on synchronization server 1314 and served directly from synchronization server 1314. The advertisement information may be uploaded to synchronization server 1314 by radio station 1334 or by a user using an application which allows the user to upload all the pertinent information such as description, location, phone number, pictures, video and audio, and assembles this into an automatically generated panel that is viewed in the playlist page or the mobile application when the user clicks on the advertisement.

In an embodiment, content associated with SIC 1304 identifiers may be stored on synchronization server 1314 and/or may be stored in a variety of other locations. For example, content associated with SIC 1304 identifiers may be available on external content repository 1423, available on a remote server accessible via the Internet 1330 and/or available from the radio station server 1308.

In one example embodiment, synchronization server 1314 may assemble all the synchronized content 1318 and send it to user device 1306 to be displayed in a playlist format on user device 1306. In one embodiment synchronized content 1318 may be displayed as a playlist in a frame displaying within a radio station website on user device 1306. Regarding the video, synchronization server 1314 may send only the URL to that video, therefore, when the user clicks on the song, or when the player automatically selects a song, the URL is invoked by the player, and is called from the user device 1306. In this way the video may display on user device 1306 without requiring the video content to route through the synchronization server or the radio station server 1308.

In another example embodiment, synchronization server 1314 may host and/or serve the radio station website content 1312 with the radio station content (like skins) and frame for music videos. The synchronization server 1314 may or may not host all the material like the music videos.

In one example embodiment, to generate synchronized content 1318, synchronization server 1314 appends additional data to the SIC content 1304 in the following way: if a playlist in SIC content 1304 received from radio station server 1308 identifies a song playing over-the-air on the radio station 1334, the synchronization server 1314 may locate a publicly available video version of the song to add to synchronized content 1318 such that the video version may be made available to play in a frame of the radio station website as displayed on a user device 1306. The synchronization server 1314 may obtain the video and/or URL from a database 1336 on synchronization server 1314 or via Internet 1330. Synchronization server 1314 may add the video content or an URL associated with the video content to synchronized content 1318 to be sent to user device 1306. Synchronization server 1314 may append additional information such as the lyrics, biography, purchase links, and/or the like to synchronized content 1318.

In an example, if SIC content 1304 calls for an advertisement, application software 1302 and/or synchronization server 1314 may integrate a video version of the advertisement with SIC content 1304. In one embodiment, when an advertisement plays on-the-air, the synchronization server 1314 may detect that an advertisement played based on metadata received from the station server 130 in SIC 1304. The video version of the advertisement may be hosted on an external content repository/database 1323, such as YouTube® or some other database server available as a host or may be hosted on the synchronization server 1314. In one embodiment, in a synchronization server backend, the station server 1308 may upload the pertinent audio, video or other materials that correspond to the advertisement. If the SIC content 1304 calls for station imaging synchronization server 1314 may have stored or may retrieve station imaging from another source, for example a remote server available over the Internet. Synchronization server 1314 may integrate the station imaging where indicated in SIC 1304 into the presentation of synchronized content 1318 on a display of user device 1306. Station images may be accessible and hosted on YouTube and/or another database server available as a host.

In an example, external content 1322 identified by SIC 1304 may be embedded in the radio station website 1312 from a third party provider comprising an external content repository/database such as YouTube, Bing Music, Yahoo Music or any available server hosting a music video, commercial, station imaging, and/or other intellectual property that may be called by the synchronization player 1340 (FIG. 15, element 1500) as directed by SIC content 1304 from SAS 1332. In an example embodiment, material may be embedded from the synchronization server 1314 automatically via application programming interface(s) (API(s)) and/or via synchronization player 1340.

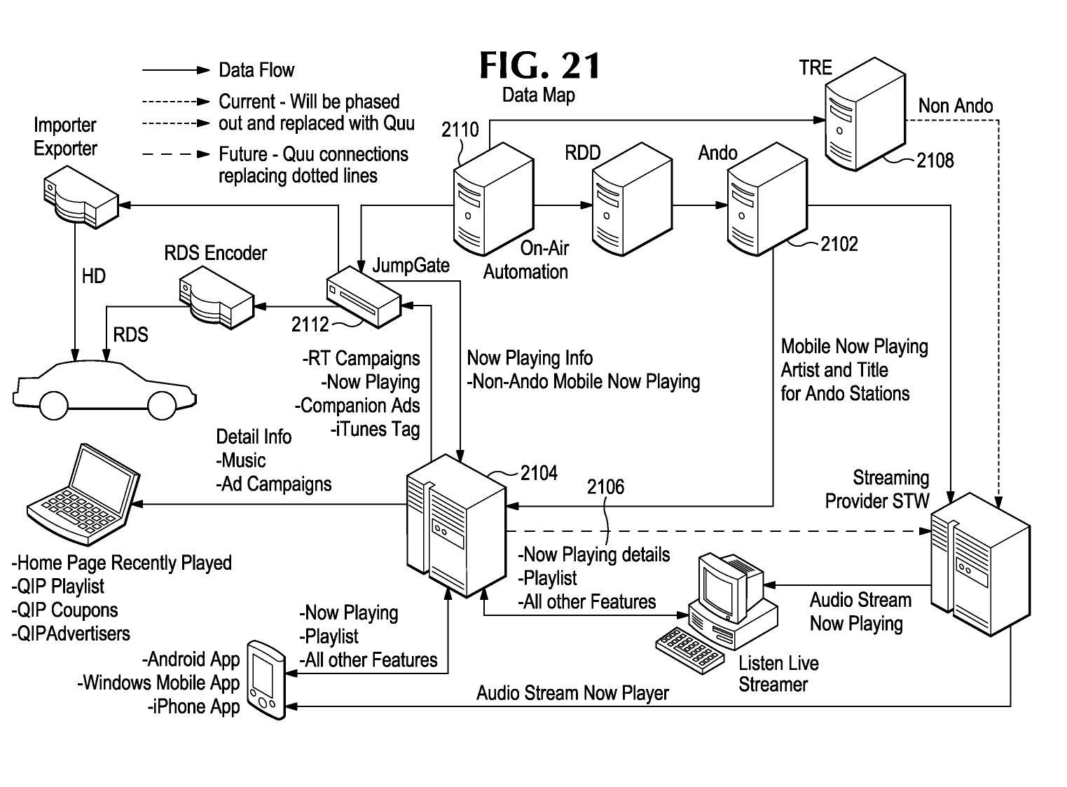

In an example, synchronization server 1314 may identify when advertisements are playing or the DJ is talking based on content identifiers in SIC 1304 coming from SAS 1332. When synchronization server 1314 and/or application software 1302 is operating in a real-time time mode approximating the over-the-air broadcast of SIC content 1304 as a virtual video presentation, application software 1302 and/or synchronization server 1314 may integrate a live audio or a video stream coming from a source provided by the station server 1308 with SIC content 1304 and stream the integrated content to user device 1306. In another example, a third party provider (for example, that services the station with a “live stream” functionality, see FIG. 21) may provide the live audio and/or video. In one example, the audio may be provided by the station, and the third party server provides the video or vice versa.

Synchronization player 1340 may also feature a social media section, where users may chat, tweet, comment, etc. about the station programming in general or about each song specifically and/or other topics. The social media area features tabs where listeners may select their mode of interaction: Facebook, Twitter, Music, and Comments, for example.

In an example, users may customize the user experience associated with accessing synchronized content 1318 via player 1340 by optionally selecting, via a button or other user input interface associate with payer 1340, to access synchronized content 1318 in a synchronized or ‘virtual live’ mode where the synchronized content 1318 is presented in substantially real-time. Alternatively, a user may select to skip certain synchronized content 1318, randomizing the station SIC 1304, using SIC content 1304 from a prior day, or requesting older or newer SIC content all of which may be presented via in player 1340 or in another format such as a library format via radio station server 1308 and/or synchronization server 1314. In an example, when the user device 1306 accesses radio station website 1312, the user device 1306 may access a video library associated with synchronization server 1314. Synchronization server 1314 may generate a video library by automatically matching the SIC content 1304 to publicly available source video on the Internet 1330 while also mixing in station imaging such as logos, or pictures of DJs of the stations, or internal videos, etc. and both video and/or audio commercials available on synchronization server 1314 between music videos.

### Advertising Campaign

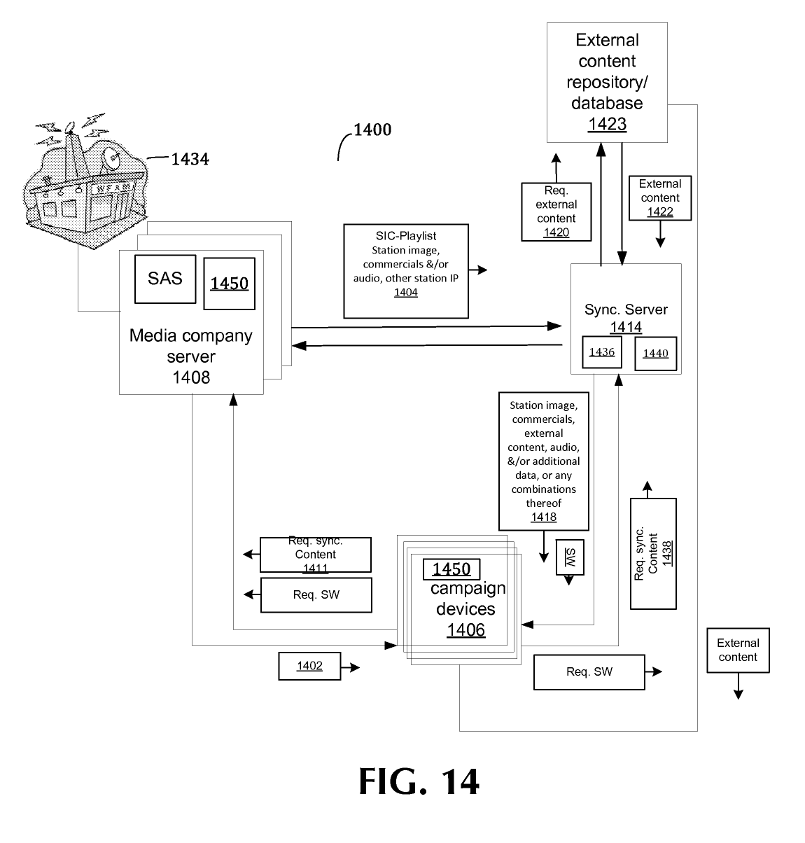

FIG. 14 depicts an example of a system 1400 for external content integration, synchronization and cross-platform advertising synchronization in a plurality of third-party devices. In an example, a variety of different user devices may access synchronization server 1414 and/or may run application software 1402 in conjunction with an advertising campaign. Synchronization server 1414 may coordinate display of content identified in SIC 1404 that is received from one or more media company servers 1408. The content display may be coordinated between one or more campaign devices 1406 or content distribution systems maintained by one company and/or across multiple independent or jointly owned companies to present content identified in SIC 1404 in a variety of campaign devices 1406. Campaign devices may comprise user devices and/or commercial devices such as: radio receivers (e.g., radio receivers enabled with HD radio or radio data system (RDS) technology), websites, electronic billboards (whether in stadiums, along freeways, in elevators, etc.), cable systems, satellite radio receivers, mobile devices, or cable systems. Presentation of content identified in SIC 1404 may be synchronized with external content associated with SIC identified content received from external content sources via an external content database 1423 or network such as the Internet in order to present a coordinated or synchronized advertising campaign. For example, when a song or an advertisement plays, metadata may be sent to the synchronization server 1414 in SIC content 1404. Synchronization server 1414 may make the same information available across variety of different device types in a coordinated distribution, for example to the web, in a car, on a mobile device, and/or any other possible electronic outlet.

In an example embodiment, a large media company may choose to display a certain message on substantially all car radio displays (that are equipped with RDS or HD Radio technology) tuned to several of the companies' radio stations in the same market or several markets. The message may contain any data such as emergency information intended to display only on one or multiple station(s) in a given city or multiple cities, the message could be an advertising message, and/or the message could be a contest related message like displaying a special call-in number. The message can be coordinated to display in conjunction with other content, such as a certain song.

Synchronization software 1450 may allow a user to also direct the messaging described above to display in a synchronized manner or simply a coordinated manner on other devices controlled or accessible by media company: listener mobile phones, company web pages, video billboards targeted again by station, by city, by region, by format, by demographic, etc.

In an example, Company A may own video billboards in New York's Times Square. Company B may own a country radio station in New York City. Synchronization software 1450 may reside on server(s) 1408 and/or devices 1406 and may enable synchronization or coordination to occur between the video billboard and the radio station so that content (advertising or otherwise) may play on the video billboard at the same time it plays on the radio station. Such coordination may be controlled via sync server 1414. In an example, if a cable company, TV company, video billboard company, radio company, Internet company or other media company employs synchronization software, an advertiser or content provider may be able to implement a cross-company, cross-media, synchronized or coordinated content campaign (advertising or otherwise). In one embodiment, an electronic billboard (one of the campaign devices 1406) may be configured to display certain advertising content while the corresponding advertising is broadcasting from radio station 1434 so that listeners tuned to the radio station in view of the billboard will see the product advertised on the billboard as well as hear about the product advertised on the radio.

An advertising client in the past may have found it necessary to purchase advertisement campaigns from multiple companies in order to create a national campaign. Each company would independently schedule those campaigns by station and by device. Whereas, system 1400 enables a national advertiser to purchase directly from a sync server provider and target an audience by station, by market/city, by video display, by platform (RDS only, HD radio only, satellite radio display only, web only, mobile only, etc.) across multiple companies, or limited by company, (as long as they employ software 1450 and/or synchronization server 1414) and software 1450 and/or synchronization server 1414 may coordinate to deploy that advertising as scheduled within its interface to all selected locations substantially without further human intervention and provide affidavits.

In one example embodiment, the Synchronization server 1414 serves information to multiple stations. The advertising engine is therefore connected to all the outlets (mobile, web, in-car) of these stations. From a central interface, the user can select an advertisement to appear on specific stations, at specific times, in between specific days, and/or when a specific event takes place such as when an artist like Justin Beiber plays. Thus, the advertisement can be directly linked to that artist.

A cable television company could ultimately require their content providers to adhere to a fixed advertisement break schedule for all channels targeting men aged 18-34. Typically, that organization would find it necessary to create an advertisement playlist for each separate channel. With software 1450 and/or synchronization server 1414, the cable system could create one slate of commercials to air on all channels targeting men aged 18-34 and the software 1450 and/or synchronization server 1414 may enable the cable system to create one advertisement playlist and the software 1450 and/or synchronization server 1414 could syndicate those commercials across all channels targeting men aged 18-34 and coordinate that campaign with all radio stations selected by an advertiser targeting men aged 18-34.

FIG. 15 depicts an example of a screenshot of a display of a synchronization player 1340 accessible from a radio station website 1308 and/or available from a synchronization server 1314. In an example, a user experience accessing synchronized content 1318 may mimic a music-video channel framed within the synchronization player 1340, wherein the shuffle of information to enable this experience exists entirely on the user's computer. The player may comprise a frame 1502 for showing a video coordinated with SIC material 1304 and a playlist 1504 displaying selectable identifiers associated with SIC 1304 content.

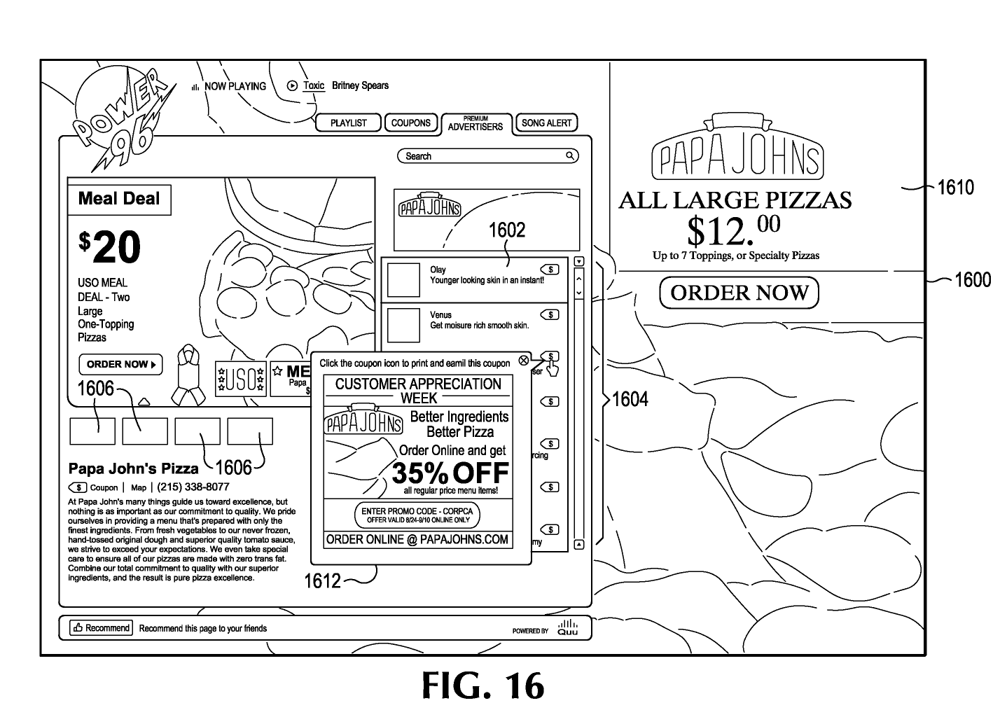

FIG. 16 depicts an example of graphical user interface (GUI) 1600 as may be displayed on user device 1306. GUI 1600 may be associated with player 1340 and/or a radio station website 1312. In an example, advertising campaigns may be associated to on-air advertisements in a synchronization server 1308. As advertisements play on the air, identifiers 1602 associated with the advertisement may appear in the advertisement playlist 1604 tab of GUI 1600 and in a full programming playlist at substantially the same time. Advertisements feature pictures 1606, video 1608, audio (not pictured), skin 1610 (i.e., a background image on website GUI 1600), request for more information, coupon 1612, description, phone number and map amongst other information.

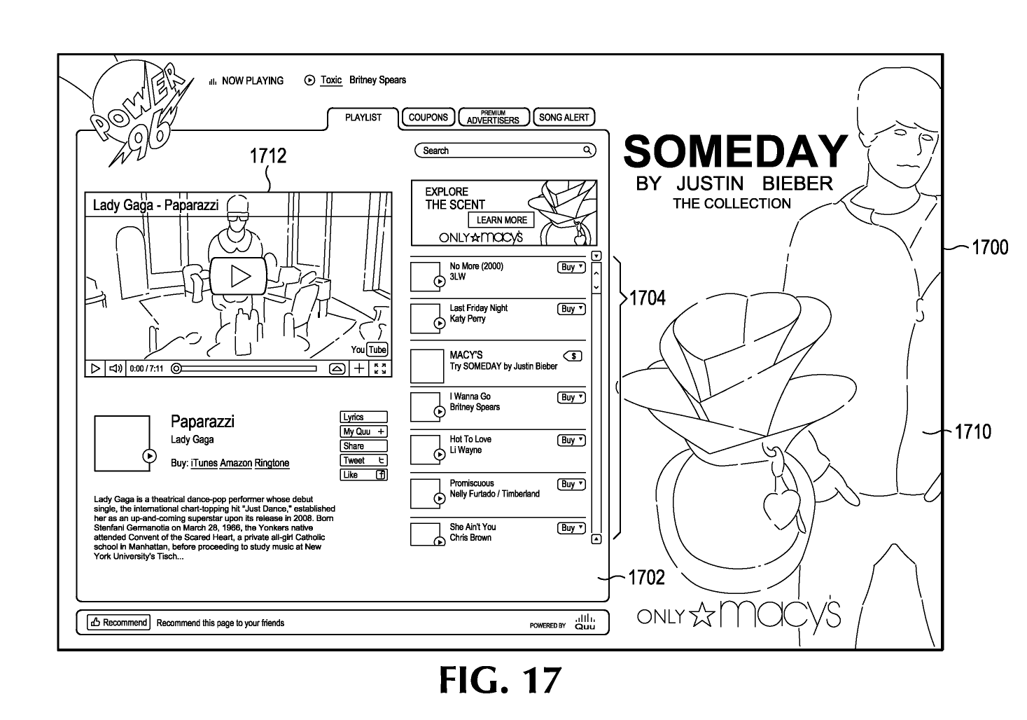

FIG. 17 depicts an example of a graphical user interface (GUI) 1700. GUI 1700 may be associated with player 1340 and/or a radio station website 1312. Advertisements and/or other content may be presented to coordinate with a specific artist or song. For example, if Lady Gaga's “Poker Face” plays in the video player 1712, the surrounding skin 1710, radio receiver displays, mobile displays, and other station assets (e.g., music radio station intellectual property) can be linked to present additional information related to that song (e.g., upcoming concert information, advertiser tie-in/sponsorship, etc.) The station assets may feature more information about the artist or an advertiser that is sponsoring the artist such as Macy's.

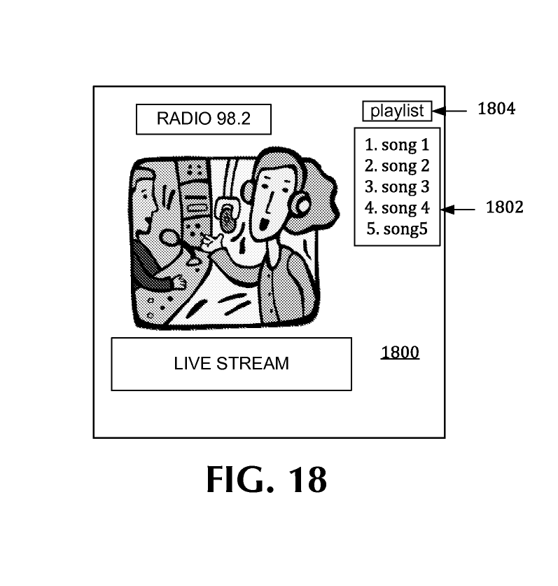

FIG. 18 depicts an example of a radio station website 1800. In one embodiment, a user may access station website content via player 1340 by selecting playlist 18040 and/or an identifier in the playlist 1802. Playlist 1802 shows a number of songs last played on that station. If the user clicks on any of these songs or on the playlist button 1804 also located in the radio station homepage, it opens the playlist page described herein.

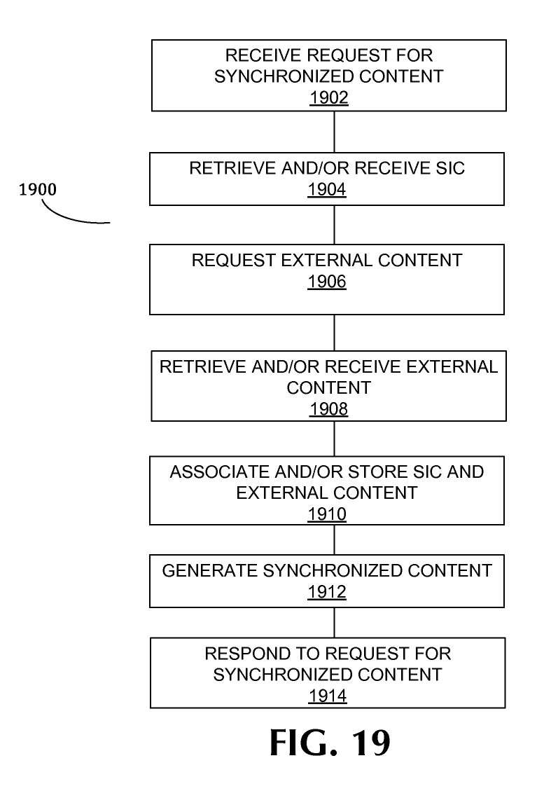

FIG. 19 illustrates an example of a process 1900 for synchronizing SIC data and supplemental data. Process 1900 will be described with references to FIG. 13.

In an example, at operation 1902, synchronization server 1314 may receive a request 1311 and/or request 1338 for synchronized content 1318. The request 1311 may be received from radio station server 1308 forwarding a request for the synchronized content 1318 from a user device 1306. Request 1338 for synchronized content 1318 may be received directly from a user device 1306.

In an example, at operation 1904, responsive to the request 1311 and/or request 1338, synchronization server 1314 may request SIC 1304 from SAS 1332 and/or radio station server 1308. In another embodiment, SAS 1332 may send SIC 1304 to synchronization server 1314 without a request, for example on a periodic basis or other basis.

In an example, at operation 1906, synchronization server 1314 may send a request 1320 for external content 1322 associated with the SIC 1304 to a source on network 1330 (e.g., the Internet or other network) and/or to external content repository/database 1323. External content 1322 may comprise content associated with content identified in SIC 1304 such as: music videos, advertisements, lyrics, interview audio, contests, URLs, social media, merchant website links and/or artist bios associated with a song that is broadcasting over-the-air.

In an example, at operation 1908, synchronization server 1314 may receive and/or retrieve external content 1322.

In an example, at operation 1910, synchronization server 1314 may associate SIC data 1304 with one or more items of external content 1322 in database 1336. Synchronization server 1314 may store SIC 1304 and/or associate external content in a database 1336

In an example, at operation 1912, synchronization server 1314 may generate synchronized content 1318. Synchronized content 1318 may comprise SIC 1304 incorporating external content 1322 obtained by synchronization server 1314.

In an example, at operation 1914, synchronization server 1314 may respond to request 1311 and/or request 1338 to provide user device 1306 access to synchronized content 1318, for example via player 1340. In an example synchronization server 1314 may send synchronized content 1318 to one or more user devices 1306 (or campaign devices 1406, see FIG. 14). In one example, application software associated with player 1340 may sent from synchronization server 1314 to a user device 1306 to facilitate running player 1340 on user device 1306. In another embodiment, synchronization server 1314 may make synchronized content 1318 available to a plurality of user devices 1406 (see FIG. 14) on a variety of platforms.

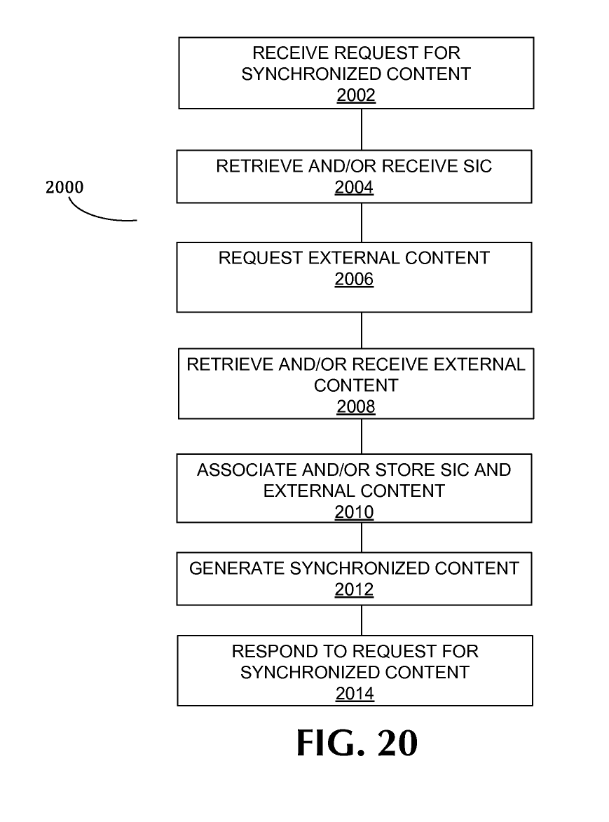

FIG. 20 illustrates an example of a process 2000 for synchronizing SIC data and supplemental data. Process 2000 will be described with references to FIG. 14.

In an example, at operation 2002, synchronization server 1414 may receive a request synchronized content 1418. The request 1411 may be received from media company server(s) 1408 forwarding a request for the synchronized content 1418 from one or more campaign devices 1406. Request 1438 for synchronized content 1418 may be received directly from one or more campaign devices 1406.

In an example, at operation 2004, responsive to the request 1411 and/or request 1438, synchronization server 1414 may request SIC 1404 from SAS 1432 and/or media company server(s) 1408. In another embodiment, SAS 1432 may send SIC 1404 to synchronization server 1414 without a request, for example on a periodic basis or other basis.

In an example, at operation 2006, synchronization server 1414 may send a request 1420 for external content 1422 associated with the SIC 1404 to a source on network 1430 (e.g., the Internet or other network) and/or to external content repository/database 1423. External content 1422 may comprise content associated with content identified in SIC 1404 such as: music videos, advertisements, lyrics, interview audio, contests, URLs, social media, merchant website links and/or artist bios associated with a song that is broadcasting over-the-air.

In an example, at operation 1908, synchronization server 1314 may receive and/or retrieve external content 1322.

In an example, at operation 2010, synchronization server 1414 may associate SIC data 1404 with one or more items of external content 1422 in database 1436. Synchronization server 1414 may store SIC 1404 and/or associate external content in a database 1436

In an example, at operation 2012, synchronization server 1414 may generate synchronized content 1418. Synchronized content 1418 may comprise SIC 1404 incorporating external content 1422 obtained by synchronization server 1414.

In an example, at operation 2014, synchronization server 1414 may respond to request 1411 and/or request 1438 to provide one or more campaign devices 1406 access to synchronized content 1418, for example via player 1440. In an example, synchronization server 1414 may send synchronized content 1418 to a plurality of campaign devices 1406 during a coordinated advertising campaign or for another campaign coordinating radio advertising and device displays associated with the radio advertising of external content. In one example, application software associated with player 1440 may sent from synchronization server 1414 to a plurality of campaign devices 1406 to facilitate running player 1440 on a plurality of campaign devices 1406 and to coordinate an advertising campaign. In another embodiment, synchronization server 1414 may make synchronized content 1418 available to a plurality of user devices 1406 (see FIG. 14) on a variety of platforms.

FIG. 21 depicts an example of a system for synchronizing SIC data and supplemental data. Ando 2102 is a streaming server for streaming radio. This way sync server 2104 can provide the Now playing information 2106 (such as artist and title). Streaming is when you listen to the radio on an internet-based device such as a phone. The stream runs parallel to the over the air radio, but not exactly at the same time as over the air advertising may not necessarily be streamed for right purposes such as the talent voice. Therefore the streaming server such as ando 2102 replaces the over the air ads with new ads meant for streaming. As ads are not the same, the streaming server manages to delay the music accordingly when the length of the ads is not the same. Ando is such server of many available on the market.

TRE {The Radio Experience) 2108 is a software that takes the data from the automation system 2110 and formats it for the RDS as well as sends the data to other 3rd party products such as Ando 2102. It is in fact the same thing as the JumpGate 2112, no difference at all. TRE 2108 has been replaced in some places. Sync server 2104 could work with TRE 2108 as a software instead of the JG 2112.

Advertising campaigns that can be linked to the artist. When a given artist is playing, an RDS Manager such as the JG or TRE or others can query Quu when a song is playing (which is the way it works for all other campaigns: RDS managers query server 2104 when the automation system 2110 indicates a new song started. They send the song to server 2104, server 2104 assembles the data to display in the player 1340, and sends back to the RDS Manager what to display in the car—same thing happens during ads or jock talk). The Artist based campaigns gets server 2104 to link what to display to the name of the artist, and sends additional information where the name of the song and the artist are linked with additional text. For example if Artist Rihanna is playing we could display the name of the song and the artist for 90 sec (configurable) then the text from the campaign such as Rihanna Live in Seattle, or follow me @rihanna, etc.

Many modifications and other embodiments of the disclosed technology will come to mind to those skilled in the art to which this disclosed technology pertains having the benefit of the teachings presented in the foregoing descriptions and the associated drawings. Therefore, it is to be understood that the disclosed technology is not to be limited to the specific embodiments disclosed and that modifications and other embodiments are intended to be included within the scope of the appended claims. Although specific terms are employed herein, there are used in a generic and descriptive sense only and not for purposes of limitation. It will be obvious to those having skill in the art that many changes may be made to the details of the above-described embodiments without departing from the underlying principles of the disclosed technology. The scope of the present disclosed technology should, therefore, be determined only by the following claims.

What is claimed is:

1. A process comprising:
receiving station identified content data;
receiving a request for synchronized content from a user device;
identifying station identified content identifiers in the station identified content data;
identifying and retrieving content associated with the identifiers from an external repository;
synchronizing retrieved content with station identified content data; and
sending synchronized content to the user device.
